(19) United States
(12) Patent Application Publication
(10) Pub. No.: US 2014/0074748 A1
(43) Pub. Date: Mar. 13, 2014

(54) System and Method for Publishing and Managing Feedback on Products Using a Merchant-Independent and User-Centric Approach

(71) Applicant: Yue Xie, Springfield, VA (US)

(72) Inventor: Yue Xie, Springfield, VA (US)

(21) Appl. No.: 14/024,614

(22) Filed: Sep. 11, 2013

Related U.S. Application Data
(60) Provisional application No. 61/699,480, filed on Sep. 11, 2012.
(60) Provisional application No. 61/830,577, filed on Jun. 3, 2013.

(51) Int. Cl. G06Q 30/02

(52) U.S. Cl. CPC G06Q 30/0282
USPC 705/347

(57) ABSTRACT

A system and method is provided for managing and publishing feedback using a merchant-independent and user-centric approach. The system comprises means for registering a user. The system also provides means for collecting, from the registered user, information verifiably indicating, to an appreciable extent, that the user has used a product identified by the collected information. The system further provides means for matching the product to an officially identified product stored in a product database. The system additionally provides means for enabling the user to provide only a single instance of feedback on the matched product. The system further provides means for enabling the user to view the feedback provided by the user on the matched product as well as the feedback provided by other registered users on the matched product.

### CROSS-REFERENCE TO RELATED APPLICATION

This application claims the benefit under 35 U.S.C. §119(e) of Provisional Patent Application No. 61/699,480, filed Sep. 11, 2012 and Provisional Patent Application No. 61/830,577, filed Jun. 3, 2013, the entire disclosures of the aforesaid applications are hereby incorporated by reference.

### BACKGROUND

1. Technical Field

The present disclosure generally relates to a system and method for publishing and managing feedback on products. The present disclosure more particularly relates to a system and method for publishing and managing feedback using a merchant-independent and user-centric approach.

2. Description of the Related Art

With the advent of Internet technologies, feedback on distinct products can be collected, published, and reviewed on various Internet-based media platforms, such as merchant web sites, discussion forums, online social networks, and so on. Conventionally, merchant-dependent and merchant-hosted feedback platforms (such as merchant web sites), particularly web sites of merchant conglomerates (such as Amazon, Walmart, Lowe's, Home Depot, Best Buys, and etc.), are predominantly the most likely platforms where a user visits in order to gather feedback information on a product (e.g. as part of the user's effort to determine whether to buy the product) or leave feedback on a product (e.g., so as to let other users know one or more aspects of the product known by the user). On the other hand, platforms hosted by non-merchants, such as discussion forums or online social networks, usually have limited feedback information on a limited number of products.

Conventional product feedback platforms, built based on a merchant-dependent and merchant-hosted approach, have apparent drawbacks. First, with the merchant-dependent and merchant-hosted approaches, feedback on a same product (such as an appliance of a particular brand name and a particular model, or a software program of a particular version on a particular platform) are scattered across various merchant web sites. Consequently, from the perspective of an investigating user who looks to gather feedback information on a particular product in order to decide whether to buy the product, the investigating user may need to visit one merchant web site after another in order to gather adequate feedback information that he/she is looking for. On the other hand, from the perspective of a feedback-supplying user, he/she may need to log into one merchant web site after another in order to get across his/her feedback on the same product. Thus, with the merchant-dependent and merchant-hosted approach, it may be inconvenient for both an investigating user and feedback-supplying user to gather feedback information and provide feedback on a particular product, respectively.

Next, with the merchant-dependent and merchant-hosted approach, the credibility, accuracy, and integrity of a product feedback platform may be compromised and called into question. In the end, for a merchant, the primary purpose of hosting feedback for a particular product (which the merchant usually carries) is facilitating the merchant to sell the product. So there is an apparent potential conflict of interest between the merchant who seeks to make a profit by selling the product and a potential buyer who seeks to ascertain the objective facts about the product through other user's feedback. This apparent conflict of interest is, to some extent, reflected by Applicant's observations that merchant web sites almost invariably allow a registered user to leave a feedback on a particular product without making any attempt to verify whether the registered user has indeed purchased (or e.g. installed) the product and to track and verify whether the registered user has already left an instance of feedback on the same product. Thus, under these considerations, the credibility, accuracy, and integrity of a product feedback platform that is merchant-dependent and merchant-hosted may be compromised and called in question.

Further, with the merchant-dependent and merchant-hosted approach, for certain types of products, such as a software program (application) which may have different platform versions each for a different operating system platform (such as iOS, Android, Mac or Windows), a merchant supplying such types of products may only supply a product for only a single platform. For example, a merchant supplying software applications, like Google Play or Apple App Store, usually only supplies a software application for a single operating system platform, such as Android or iOS, with which the merchant is affiliated. Thus, such a merchant—even if, e.g., having the means to verify whether a feedback-supplying user has indeed downloaded a version of a software application—usually only collects and publishes feedback on software applications for the single platform with which the merchant is affiliated. As a result, with the merchant-dependent and merchant-hosted approach, if an investigating user would like to gather feedback information on different versions of a software application for different platforms, the investigating user is forced to visit a different merchant for each different platform, which is inconvenient for the investigating user.

Therefore, in view of the drawbacks discussed above in connection with conventional product feedback platforms built based on a merchant-dependent and merchant-hosted approach, there is a need for a feedback platform built using an approach away from a merchant-dependent and merchant-hosted approach so as to address the above-discussed drawbacks.

### BRIEF SUMMARY

In one aspect, the present disclosure provides a feedback publishing and management platform (system) and method using a merchant-independent and user-centric approach. Specifically, the disclosed published and feedback management system and method (hereinafter simply referred to as “the disclosed FM system” or “the disclosed FM method”) aggregates feedback on products from individual registered users regardless of merchants from which the users have purchased or otherwise acquired different products. In collecting feedback (e.g. rating and/or review) on a particular product from a registered user, before prompting and letting the user provide feedback on the product, the disclosed FM system and method collects and verifies objective and concrete documentation reliably indicating that the user may have used or experienced the product. With the verification mechanism, the credibility, accuracy and integrity of product feedback information which the disclosed system and method publishes is to a great extent uncompromised. In one embodiment, the disclosed system and method may provide means to let an individual registered user update or augment his/her ratings on a particularly product, and prevent or reduce the possibility that the same user ends up providing numerous instances of feedback for the purpose of, e.g., artificially affecting, inflating or flooding the rating and otherwise feedback on the product.

In another aspect, the disclosed FM system and method, in collecting and verifying objective and concrete documentation indicating that a user may have used or experienced one or more products, accesses on behalf of the user one or more corresponding accounts which a user has with one or more merchants from which the user purchased or otherwise acquired the products, receives relevant documentation (such as purchase history) from the accessed one or more merchant platforms, and extracts information relating to purchases or acquisitions which the user made, and verifies that the user has purchased or otherwise acquired one or more identifiable products from or through the one or more merchants.

In yet another aspect, the disclosed FM system and method, in collecting and verifying objective and concrete documentation indicating that a user may have used one or more software applications (products), provide a custom software application installed on a computing device of user. The custom software application includes means to collect, with the user's consent and on behalf of the user, information regarding software applications that have been installed on the user's computing device, and communicates the collected software installation information to a backend server of the disclosed FM system and method. In one embodiment, the custom software application may additionally include means to collect, with the user's consent and on behalf of the user, usage information of one or more installed software applications, and communicates the collected usage information to the backend server.

In yet another aspect, the disclosed FM system and method provides graphical user interfaces enabling a user to enter the user's feedback on a product for which the user has been verified to have purchased, installed or otherwise acquired. The user feedback may include the user's rating on the product and the user's review on the product. In one embodiment, the disclosed FM system and method, via mechanisms including a product matching scheme and provided custom user interfaces, enables the user to update the user's feedback while ensuring that the user cannot provide more than one instance of feedback on an identified product for illicit purposes. Additionally, the disclosed FM system and method provides graphical user interfaces enabling a user to view feedback information on a product which the user provides as well as the feedback information on the product which other registered users provide. Furthermore, for software programs (products), the disclosed FM system and method provides graphical user interfaces that enable a user to view feedback information on different platform versions of a software program (each for a different platform), thus facilitating the user's purchase decision with regard to one or more specific platform versions of the software program.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements may be exaggerated relative to other elements. Embodiments incorporating teachings of the present disclosure are shown and described with respect to the figures presented herein, in which:

FIG. 1 is a general diagram illustrating an exemplary operating environment of the disclosed FM system and method, according to one or more embodiments of the present disclosure.

FIGS. 2A-C are diagrams illustrating a backend system 102 of the disclosed FM system and method, according to one or more embodiments of the present disclosure.

FIGS. 3A-B are diagrams illustrating an exemplary client device 101, according to one or more embodiments of the present disclosure.

FIG. 4 is a flowchart illustrating an exemplary main process through which the disclosed system enables a user to provide feedback on a particular product which has been verified to have been likely used by the user, according to one or more embodiments of the present disclosure.

FIGS. 5A-E are figures, which include a flowchart, pictorials and code snippets, provided to illustrate an exemplary means provided by the disclosed FM system and method to implement block 402 for merchandise goods.

FIGS. 6A-B are figures, which include a flowchart and code snippets, provided to illustrate an exemplary means provided by the disclosed FM system and method to implement block 402 for merchandise goods.

FIGS. 7A-D are pictorials illustrating exemplary UIs provided to enable the user to provide feedback on one or more certified products of the user, according to one or more embodiments of the present disclosure.

FIGS. 8A-G are pictorials illustrating exemplary UIs configured to enable the user to view the user's own feedback on a certified product of the user as well as other user's feedback on one or more certified products.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, and “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. A reference alpha-numeral (such as “501A”) may refer to one implementation or one portion of one element or a plurality of like elements bearing the same base reference numeral (such as “501”). The specific identifiers/names, reference numerals and reference alpha-numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows or requires, may be used interchangeably to refer to one or more sets of computer instructions adapted to perform, when executed by a processor (such as a microprocessor or a microcontroller), one or more specific functions.

As used herein, the term “product” refers to any good provided to a customer by a merchant, so long as the good is uniquely identifiable by text values for a set of categories used collectively to identify the good.

As used herein, the terms “feedback”, “review” and “rating”, so long as allowed by the context, may be used interchangeably to refer to a user's reaction or evaluation on a product, as expressed in the form of at least one of text, image (including still images and videos), audio, or any combination thereof. In some instances, the term “rating” may refer to a provided value (which may be expressed with a numerical value or with one or more visual images) that represents a result of the comparison of the provided value against a maximum value.

As used herein, the term “purchase” should be broadly construed to encompass any transaction or scenario where a consideration is used to acquire one or more products, regardless of whether monetary exchange is included in the consideration.

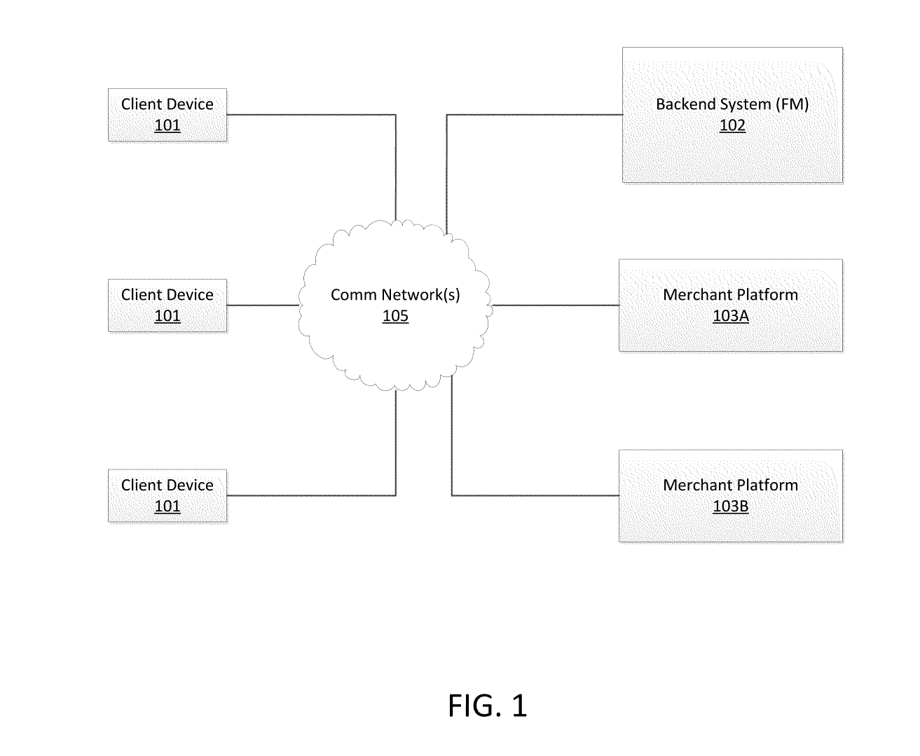

With reference now to the figures, and beginning with FIG. 1, there is depicted a general diagram illustrating an exemplary operating environment of the disclosed system and method, according to one or more embodiments of the present disclosure. Referring to FIG. 1, the operating environment of the disclosed FM system and method may comprise a backend system 102 for the disclosed FM system, a plurality of third-party merchant platforms 103 (such as merchant platforms 103A and 103B), and a plurality of networking-capable client devices 101. Each of backend system 102, merchant platforms 103 (such as social media platforms 103A and 103B), and a plurality of network-capable client devices 101 are communicatively coupled to each other through one or more communication networks 105, which may include Internet and/or one or more interconnected networks, such as one or more cellular networks or one or more local area networks.

A merchant platform 103 is used by a merchant to conduct its business online. One exemplary form of a merchant platform is a web site through which the merchant, for example, receives purchase orders from users. Examples of a merchant's web site include Amazon.com, EBay.com and Walmart.com. Another exemplary form of a merchant is a service portal through which the merchant, for example, enables users to download software programs or receive services provided by the merchant's own backend proprietary software programs. Examples of a merchant's service portal include Google Play and Apple's App Store. As will be illustrated below, backend system 102 of the disclosed FM system may communicate with one or more merchant platforms 103 so as to collect and verify a user's product purchase or acquisition information.

In the present disclosure, the terms “merchant”, “merchant platform” and “merchant web site”, depending on the context in which any of the terms are used, may be used interchangeably refer to a merchant platform 103, an entity owning or operating the merchant platform (such as the Amazon Corporation owning or operating Amazon.com), or a combination of both. Similarly, the term “backend system 102”, depending on the context in which the term is used, may refer to the backend system 102 of the disclosed FM system, an entity owning or operating the backend system 102, or a combination of both.

A client device 101 can be any computing device having networking capabilities and loaded with one or more client applications enabling a user to perform various specific functions. Examples of a client device 101 may include a smart phone, a PC, a notebook computer, a tablet and a PDA. Applications running on a client device 101 are commonly referred to as “apps” when the client device is a smart mobile device such as a smart phone or a tablet PC. As used herein, the terms “client application” refers to a software application running on a client device 101.

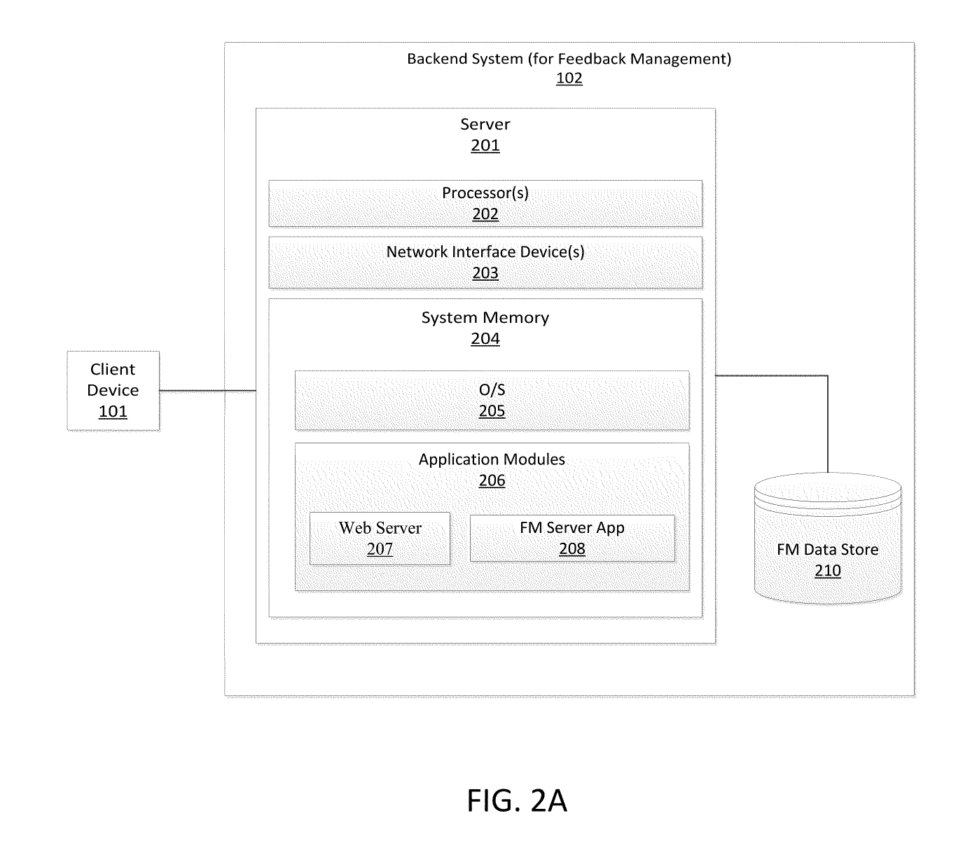

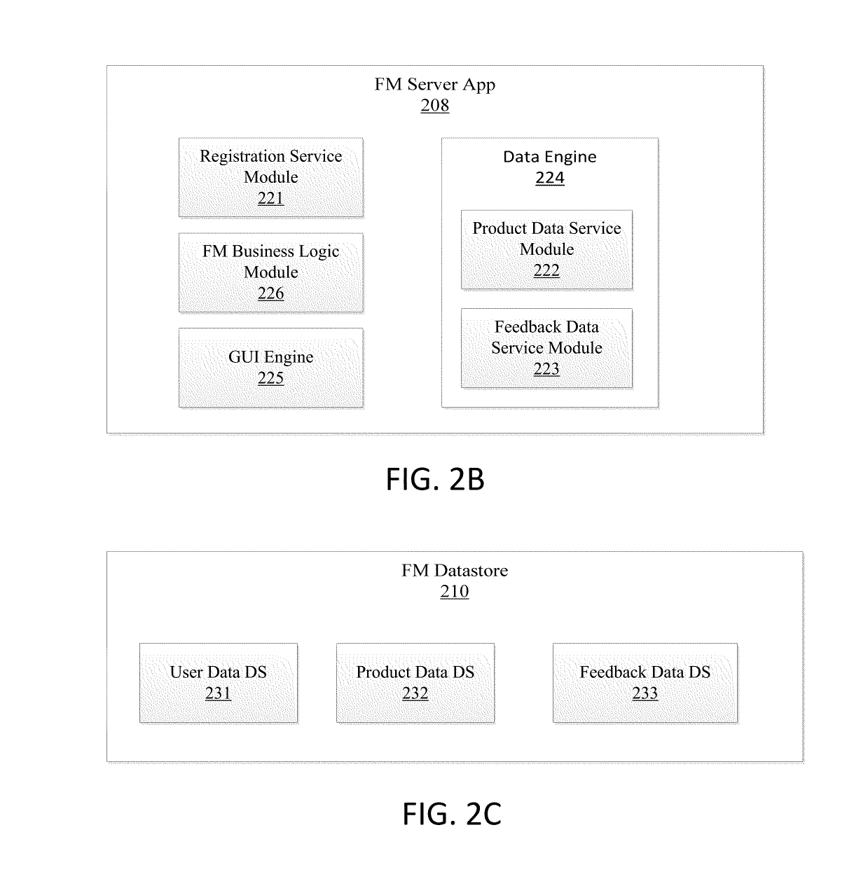

FIGS. 2A-C are diagrams illustrating a backend system 102 of the disclosed FM system and method, according to one or more embodiments of the present disclosure. Referring to FIG. 2A, which is a block diagram illustrating an exemplary backend system 102, backend system 102 may comprise server 201 and feedback management (FM) data store 210 (hereinafter referred to as “FMDS 210”). As used herein, the term “server” refers to any of various types of computing devices, such as computer clusters, server pools, general-purpose personal computers, workstations, or laptops. Server 201 comprises, inter alia, one or more processors 202 (such as one or more microprocessors), one or more network interface devices 203, and one or more system memories 204. During an operation of server 201, software modules or firmware modules, such as operating system 205 and application modules 206, are loaded into system memories 204. These software or firmware modules, when executed by one or more processors 202, are adapted to perform various functions for which their respective programmatic (software) codes are programmed.

Application modules 206 may be implemented in various forms, such as standalone executable programs, callable functions and routines, scripts that can be executed via running of one or more interpreter programs, services that may be invoked by one or more standard or proprietary protocols, and programmatic objects containing both data and callable functions.

In one embodiment, Application modules 206 may include a web server module 207 and an FM server application module 208. Web server module 207 may be programmed and configured to receive web requests from a client application (such as a web browser) of a client device 101 and deliver a corresponding web response to a client application. Referring to FIG. 2B, which is a diagram illustrating exemplary component modules of FM server application module 208, FM server application module 208 may comprise registration service module 221, data engine 224, graphical user interface (GUI) engine 225, and FM business logic module 226 as component modules.

Registration service module 221 is programmed and configured to provide user registration service handling a user registration request received from a user. Data engine 224 is programmed and configured to store and retrieve FM related data in accordance with needs of FM business logic. In one embodiment, Data engine 224 stores received FM-related data in FMDS 210 and retrieves requested FM-related data from FMDS 210. Data engine 224 may include product data service module 222 and feedback data service module 223. Product data service module 222 may be programmed and configured to service (store and retrieve) product-related data, which, inter alia, may include data identifying a plurality of products. Feedback data manage module 223 may be programmed and configured to service (store and retrieve) feedback-related data, which, inter alia, may include feedback information on products as provided by registered users.

GUI engine 225 may be programmed and configured to generate specific UI instructions which may include both presentation semantics and FM-related data (which may be provided by data engine 224) to be displayed on a client device 101 for viewing. Typically, these generated UI instructions would be subsequently provided (transmitted) to a client application (such as a web browser) by backend system 102 (through, for example, web server module 207) via one or more communication channels between the client device 101 hosting the client application and backend system 102. Thus, for illustration and not limitation, GUI engine 225 may generate UI instructions to render UIs to enable a user to perform functions, such as signing up (registering) with backend system 102, logging into backend system 102, registering (adding) one or more merchants with backend system 102 (for acquiring from the merchants the user's purchase-related information on behalf of the user), providing feedback information on a certified product, viewing a user's own feedback information (on a verified product) and/or feedback information (on a product) provided by other users, and so on. GUI engine 225 may not be needed (and thus may be optional) if a client application used to display UIs for the disclosed FM system and method is not a browser, but an “app” (or, in other words, a custom application) specifically programmed and configured to work in concert with backend system 102 in regard to UI displays.

FM business logic module 226 is programmed and configured to perform business logic required for performing feedback management and publishing functions of the disclosed FM system. FM business logic module 226 may be called by other modules, such as web server module 207, registration service module 221, or a system module (as a module invoking one or more cron jobs performing routines required for the disclosed FM system), so as to handle user requests or perform daily routines. FM business logic module 226 may call other component modules, such as data engine 224, GUI engine 225 or web server module 207, to carry out business logic in handling the user request or performing daily routines. The performing of business logic may include delivering a response to the user following the handling of the user request.

FMDS 210 is communicatively coupled to server 201. FMDS 210 may exist or be implemented in one or more of various forms, such as one or more local or distributed relational or objective databases, one or more local or distributed file systems, one or more removable storages, one or more memory caches, one or more memory clusters, or any combination thereof. In one embodiment, FMDS 210 resides in server 201. In another embodiment, FMDS 210 resides external to server 201. FMDS 202 may be configured to store data which the disclosed FM system collects and uses in providing feedback management and publishing functions, as will be disclosed in more details below.

Referring to FIG. 2C, which is a diagram illustrating exemplary component modules of FMDS 210, FMDS 210 may include user data DS 231, product data DS 232 and feedback data DS 233 as component data stores. User data DS 231 may be configured to retrievably store user data, such as user registration data, which may include identifiers used to identify registered users, user profile data, user purchase data and user product usage data. Product data DS 232 may be configured to retrievably store product data, which may include data identifying a plurality of products, such as values or data (text, image or audio) for categories collectively used to identify and/or describe a merchandise good (such as a camera, a watch, an appliance, and so on) or a software program. Feedback data DS 233 may be configured to retrievably store feedback data (on products) provided by registered users, which may include respective ratings and reviews on products. In one embodiment, component data stores, such as user data DS 231, product data DS 232 and feedback data DS 233 are linked to one another. For example, feedback data DS 233 may be linked to both user data DS 231 and product data DS 232, and user data DS 231 may be linked to product data DS 232.

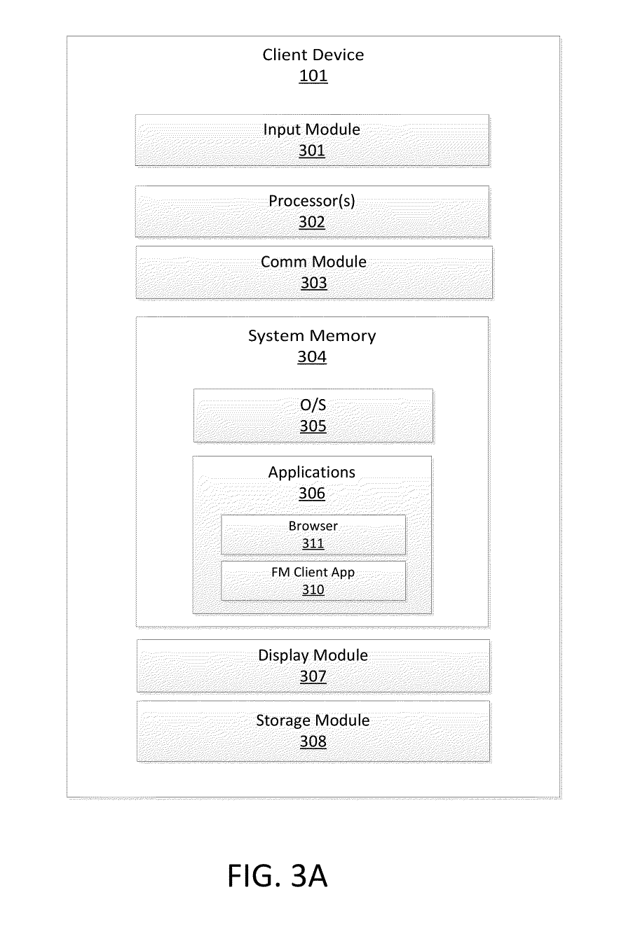

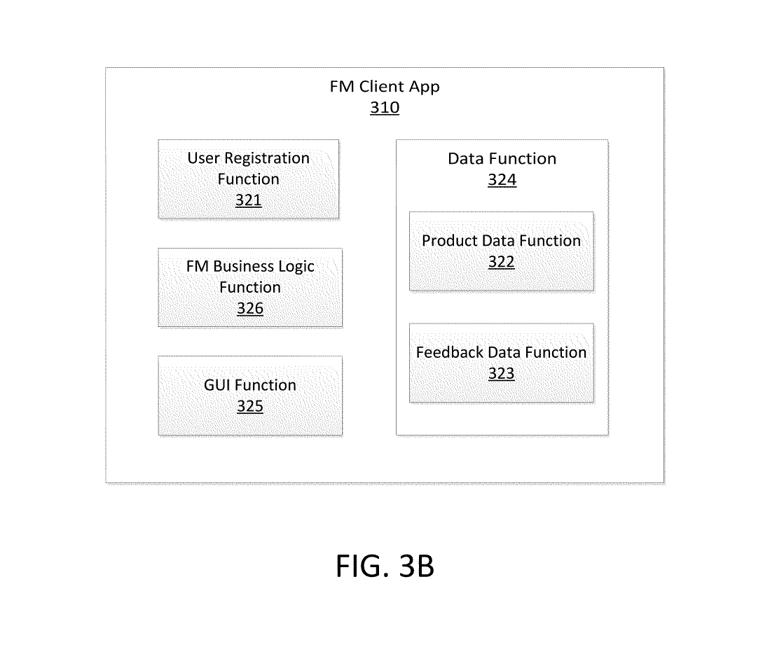

FIGS. 3A and 3B are diagrams illustrating an exemplary client device 101, according to one or more embodiments of the present disclosure. Referring to FIG. 3A, which is a block diagram illustrating an exemplary client device 101, a client device 101 may comprise, inter alia, an input module 301, one or more processors 302, communication and interface modules 303, a system memory 304 (which may include an operating system 305 and client applications 306), a display module 307, and a storage module 308.

Examples of a processor 302 include a microprocessor and a microcontroller. The input module 301 receives input from a user and provides the received input to processors 302 for further processing by software programs running in processors 302. The input module 301 may include a keyboard, an input pointing means (such as a mouse, a touchpad, a touch screen, or any combination thereof), input keys, or any combination thereof. Communication and interface modules 303 may provide wired and/or wireless networking capabilities and capabilities of interfacing with other external devices. Communication and interface modules 303 may include one or more communication devices (such as network interface device (NID), an RF unit, and antenna, or any combination thereof) and/or one or more interfacing devices (such as one or more USB connectors), as well as software or firmware modules driving or supporting aforementioned communication and/or interfacing devices. Display module 307 may include one or more display devices, such as an LCD display screen, that is used to display user input data or output data provided by an application running in the shown client device. Display module 307 may include a touch screen which also allows user to input data. In that case, Display module 307 may also serve as an input device (particularly an input pointing means) included in input module 301. Storage module 308 may include various internal and external storage media, such as RAM, ROM, hard disk, smart card, flash memory, and any external storage accessible via, e.g., the communication module or an interface module (not shown) of the client device, such as a USB interface.

One or more client applications 306 may be loaded into the system memory during an operation of a client device 101. Non-browser client applications are commonly referred to as “apps” when client device 101 is a smart mobile device such as a smart phone or a tablet PC. A non-browser custom client application 306 may exist in various forms. For example, a non-browser custom client application 306 may be a standalone application running in a smart phone, a tablet, PC or notebook computer. A non-browser custom client application 306 may also be a software module running inside a specific application context, such as a so-called “Facebook app” running inside a Facebook context (a social networking context), or either a Java applet or an ActiveX control running inside a web browser (which is also a client application 306).

In one embodiment, client applications 306 may include a web browser 311, which renders HTML pages received from backend system 102. In another embodiment, client applications may additionally or alternatively include a feedback management (FM) client application 310, which is a non-browser custom application 306 (or, in other words, an “app”) implemented and provided as an integral part of the disclosed FM system and method. Referring to FIG. 3B, which is a diagram illustrating exemplary component modules of custom client application 310, custom client application 310 may comprise client-side user registration function 321, client-side data function 324, client-side GUI function 325 and client-side FM business logic function 326, as component modules.

User registration function 321 may be programmed and configured to collect user registration data, package the collected data, and transmit the packaged data, along with a request for user registration or user login, to backend system 102. User registration function 321 may additionally receive information related to user registration (such as user up-to-date registration data or information indicating whether a user has been successfully authenticated) from backend system 102.

Data function 324 may be programmed and configured to send one or more requests for FM-related data to backend system 102, and receive requested data from backend system 102. Data function 324 may further include product data function 322 (which is for FM-related product data) and feedback data function 323 (which is for FM-related feedback data).

GUI function 325 is the client-side alternative or additional implementation of UIs otherwise provided by GUI engine 225 of backend system 102 (working in concert with the client-side web browser 311). Thus, GUI function 325 may be programmed and configured to render UIs to enable a user to perform FM-related functions, such as signing up (registering) with backend system 102, logging into backend system 102, registering (adding) one or more merchants with backend system 102 (for acquiring from the merchants the user's purchase-related information on behalf of the user), providing or updating feedback information on a certified product, viewing a user's own feedback (on a certified product) and/or feedback (on the same certified product) provided by other users, and so on. GUIs rendered by GUI function 325 may display FM-related data for viewing. Thus, GUI function 325 may receive data from data function 324 before rendering one or more corresponding UIs displaying the received data.

FM business logic function 326 may be programmed and configured to perform FM-related business logic on a client device 101 (hereinafter referred to as “client-side business logic”). Such client-side business logic may include performing validity check on data collected from the user through UIs displayed on the client device 101 before sending the collected data to backend system 102, and processing data received from the backend system 102 (as provided by data function 324) and providing processed data to GUI function 325 for display.

Such client-side business logic may also include collecting FM-related related data available (sometimes only available) on a user's client device 101. In one embodiment in connection with feedback publishing and management functions related to software products, FM business logic function 326, as a component module of an FM client application 310, may be configured to collect, on behalf of the user, information regarding one or more software programs installed on the client device 101 and/or information regarding usage of one or more installed software programs, as a way to verify whether the user has indeed used one or more software programs. In one embodiment, FM business logic function 326 may provide the collected information (related to software programs) to data function 324, which then transmits the collected information to backend system 102. In one embodiment, FM business logic function 326 may be invoked whenever an FM client application 310 is running on the client device 101 so as to collect up-to-date installation and usage information on software programs installed on the client device 101.

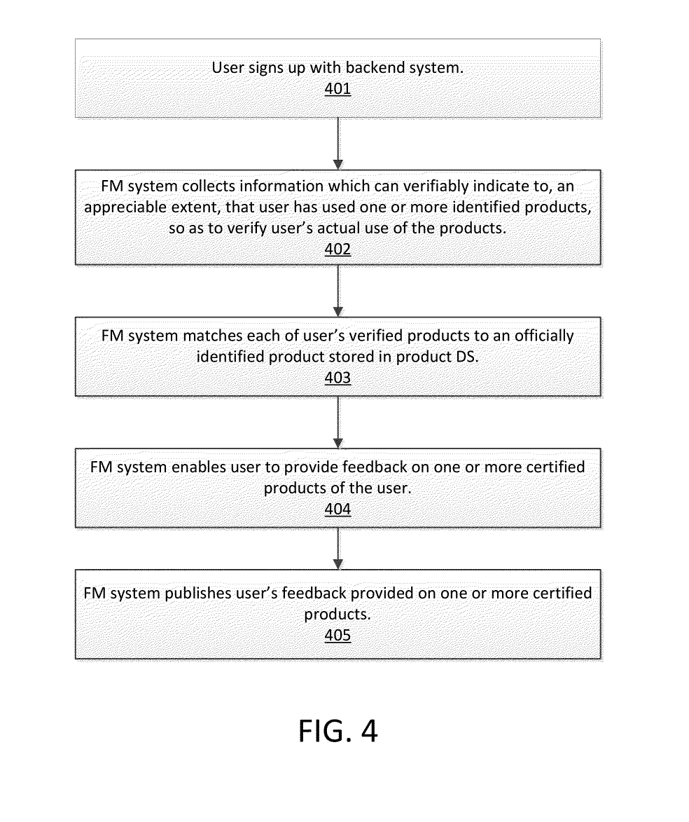

FIG. 4 is a flowchart illustrating an exemplary main process through which the disclosed FM system enables a user to provide feedback on a particular product which has been verified to have been likely used by the user, according to one or more embodiments of the present disclosure. As used herein, the terms “block” and “step” may be used interchangeably to refer to a set of programmatic (software) code or instructions adapted to perform one or more specific functions when executed by one or more processors.

At block 401, a user signs up (or, in other words, registers) with backend system 102 (via server 201) of the disclosed FM system and method. With the disclosed FM system, as a registered user, the user may provide the user's feedback information on one or more products verified to have been possibly used by the user, and have the provided feedback information published via backend system 102. In one embodiment, the sign-up procedure, including UIs used and the backend handling of received registration information, is similar to that used by the conventional art of signing up (registering) a user for conducting an online business.

For example, during a sign-up process, backend system 102 may have a client device 101 display a sign-up form (via a client application 306 such as browser 311 or an FM client application 310) with which the user can provide personal information such as name, gender, address, phone number, e-mail (which may be used as a username), username, password, confirmation of password, one or more check boxes for terms and conditions, and a CAPTCHA entry (for defending or preventing “bots” from hacking the backend system). Once the user fills in the sign-up form and clicks a “submit” button on the form, the personal information which the user provided with the form is submitted to backend system 102. Upon receiving the submitted request for registration as well as received user registration information (via, e.g., web server module 207 of server 201), backend system 102 processes the received user registration information (via, e.g., registration service module 221 of server 201). The processing may include, inter alia, establishing an account for the request user, assigning an identifier (ID) which uniquely identifies the requesting user for the user account, storing the received user registration information for the established account in user data DS 231 of FMDS 210, and sending a confirmation message (for display) to the client application 306.

An alternative or additional “social-network” sign-up (which is well known)—namely, sign-up and/or login using the user's authentication into an online social network (such as Facebook, LinkedIn, and Google Plus) with which the user has already signed up and had an account—may also be provided for simplifying the sign-up and/or login process. As known, a “social-network” sign-up or login enables backend system 102 to directly receive personal information as well as social network information of a user from an online social network through a session token or authentication token provided by the platform of the online social network when the user has been authenticated into the online social network. In one implementation, a user may sign-up and/or log into backend system 102 by clicking on a specially configured “social-network” sign-up button and going through one or more authentication steps required by the online social network.

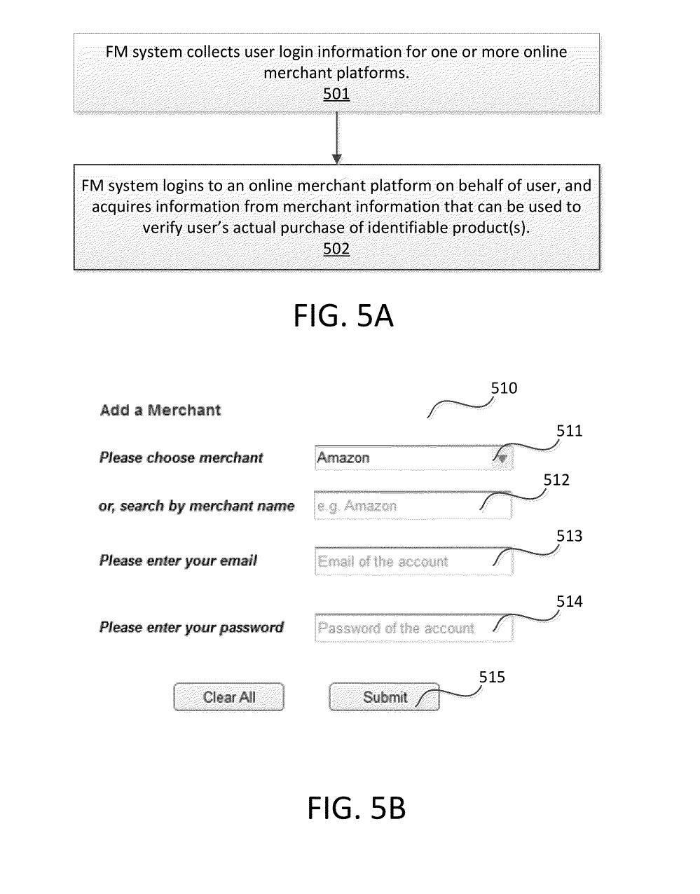

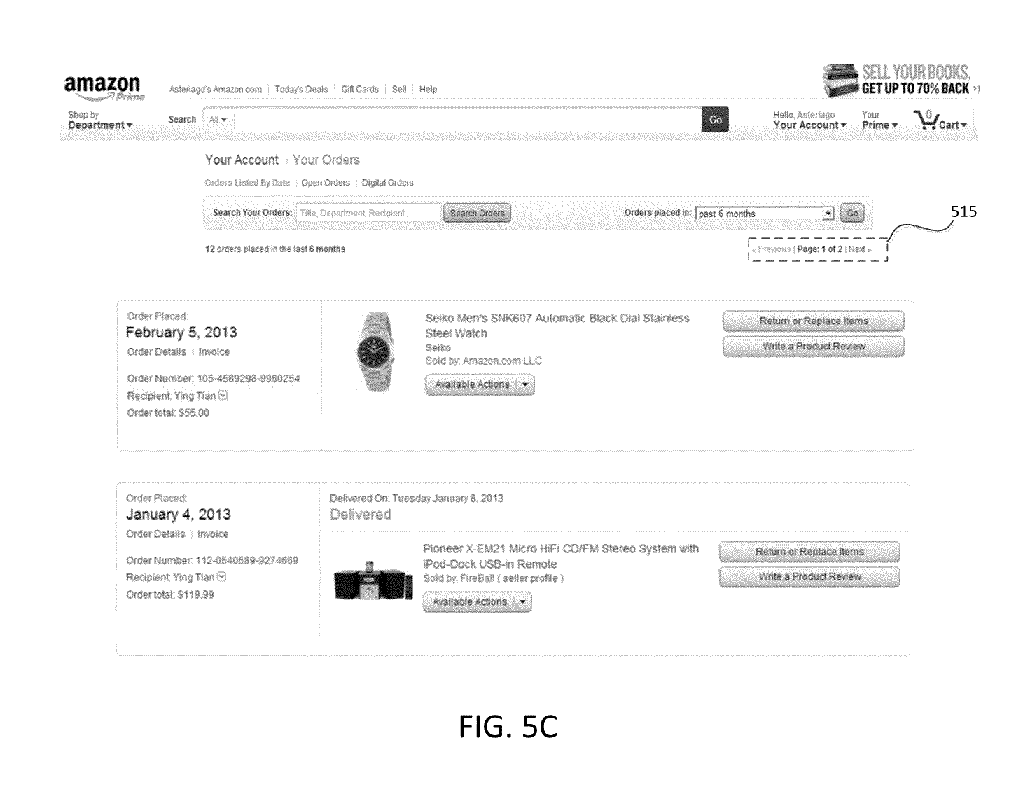

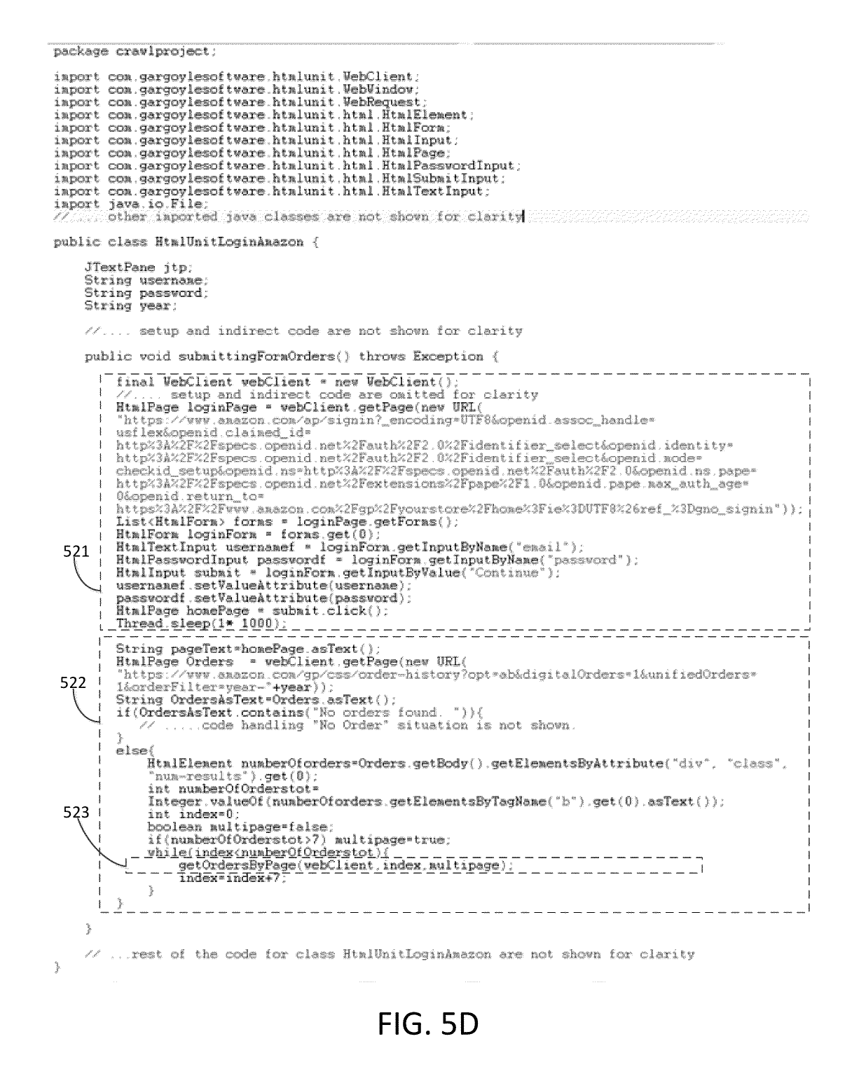

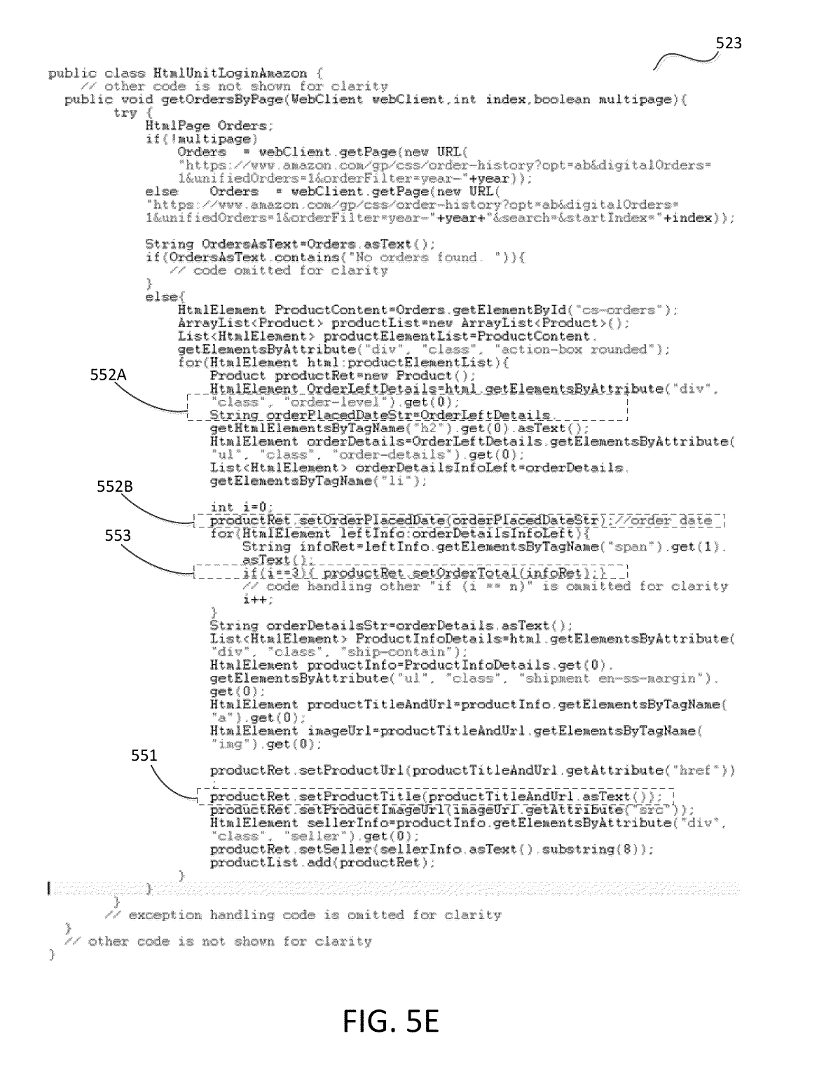

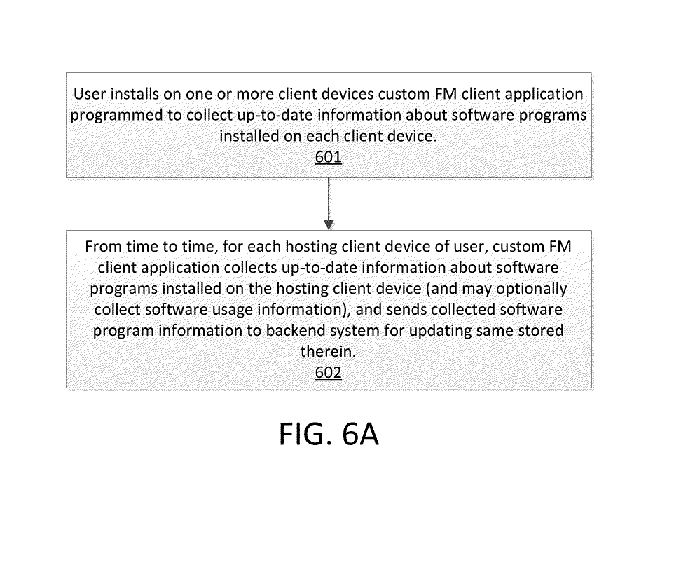

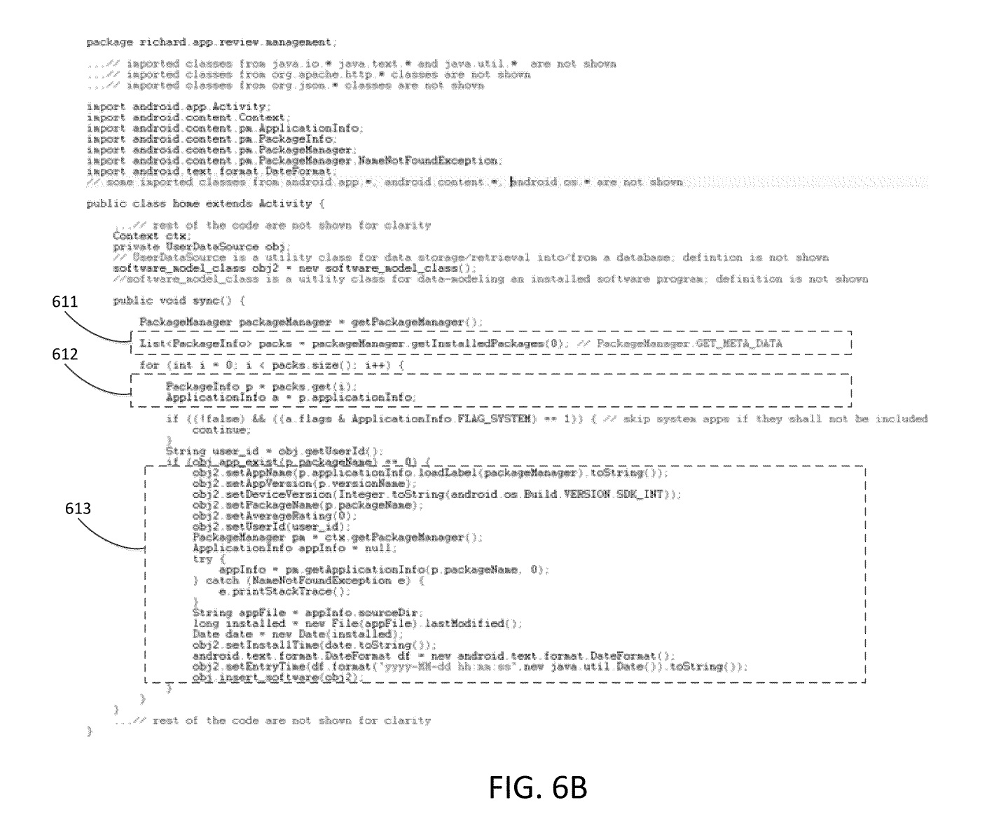

At block 402, the disclosed FM system collects, from a registered user, information which can verifiably indicate to, an appreciable extent, that user has used one or more identified products, so as to verify the user's actual use of the products. Specifically, after a user has registered and established an account with backend system 102, the user may be allowed to leave a feedback on one or more identified products using means provided by the disclosed FM system and method, provided that there is objective evidence indicating with an appreciable probability that the user has actually used or experienced the products. This measure is provided by the disclosed FM system to provide and maintain an appreciable level of credibility, accuracy and integrity of the feedback left and published by its registered users. Block 402 is calculated to help to achieve this objective. By way of example and FIGS. 5A-E and FIGS. 6A-B are two sets of figures illustrating two exemplary means provided by the disclosed FM system and method to implement block 402 for two exemplary types of products—namely, merchandise goods (products) and software programs (products)—respectively.

Referring to FIGS. 5A-E, for implementing block 402 in connection with merchandise products, one type of such objective evidence sought to collect in block 402 is purchase-related online documentation (generated in the course of a merchant's online business) indicating that a customer actually purchased one or more products from the merchant. This is because common sense tells us that the user's purchase of a merchandise product, to an appreciable extent, indicates that the user may have used the merchandise product, and thus may be suitable to provide feedback on the merchandise product. One known form of documentation is an online purchase or order history generated and displayed (for viewing) on demand made by an online customer registered with the merchant's e-commerce platform. FIGS. 5A-E illustrate an exemplary implementation used to access the user's purchase-related information from one or more merchant e-commerce platforms. FIG. 5A is a flowchart illustrating an exemplary process used to access the user's purchase-related records provided by one or more merchant e-commerce platforms and extract purchase-related information from the accessed record.

At sub-block 501, the disclosed FM system collects, from a registered user, the user's login information for e-commerce platforms of one or more merchants from which the user made one or more purchases. FIG. 5B is pictorial illustrating an exemplary UI 510 provided by the disclosed FM system to enable the user to add (register) merchants, which the disclosed system and method can access so as to acquire the user's purchase-related information. The UI is displayed on a client application 306, which may be a web browser 311 (via, e.g., GUI engine 225 of backend system 102) or a custom FM server application 310 (via, e.g., GUI function 325).

As shown, the user may input the name of a merchant—which the user would like to add into the list of merchants, from which the user provides consent to the disclosed FM system to collect the user's purchase-related online documentation—using either drop-down list box 511 or a custom text input field 512. The consent may also be provided by the user via, e.g., a click-wrap “terms and conditions” agreement provided on a sign-up form which the disclosed FM system uses to sign-up a user at block 401. In one implementation, list box 511 may include a list of online merchants (hereinafter simply referred to as “supported merchants”)—each of which the disclosed FM system “supports” by, e.g., implementing custom software modules (at backend system 102) tailor-made to access purchase-related documentation of an account holder thereof (who is also a registered user of the disclosed FM system)—and extract from the purchase-related documentation detailed information regarding purchases as applicable to enabling the user to leave feedback on one or more particular identifiable products. In one implementation, text input field 512 is custom programmed (e.g., using Javascript and AJAX in a browser context if the client application 306 is browser 311) to list one or more suggestions of supported merchants as the user types such that the user is only allowed to input a merchant that is one of the supported merchants of the disclosed FM system.

Additionally, the user may input the login information (which the user uses to log into the inputted merchant), such as user name (which may be an e-mail address) and password for logging into the inputted merchant, via text input fields 513 and 514, respectively. Clicking the “submit” button 515 results in the inputted merchant's name as well as the corresponding user name and password being submitted to backend system 102. Upon receiving the submitted login information for the inputted merchant, backend system 102 adds (registers) the received merchant information and merchant login information (via, e.g., FM business logic module 226 and data engine 224) into a “merchant list” of the user stored under the user's registered account (in, e.g., user data DS 231 of FMDS 210). Using UI 510 and repeating the same above-described steps in connection with inputting a merchant, the user may add additional supported merchants to the user's merchant list.

At sub-block 502, the disclosed FM system logs into one or more online merchant platforms on behalf of the user, and acquires from the merchant platforms information that can be used to verify the user's actual purchase of one or more identifiable products. Specifically, after the user provides login information for one or more online merchants to backend system 102, backend system 102 may, for each of the one or more online merchants, try to log into the user's account with the merchant online platform using the user-provided login information. After backend system 102 successfully logs into the user's online account with the merchant, backend system 102 is granted by the merchant platform (via, e.g., a session established between the merchant platform and backend system 102) access to the user's private records (stored, e.g., in the backend of the merchant platform), including the user's records of past purchases made from the merchant. Subsequently, backend system 102 invokes software code (hereinafter simply referred to “crawler module” or “crawling code” for the ease of discussion) specifically programmed to crawl displayable purchase-related online documentation (such as web pages) otherwise presented (provided) to the user when the user manually logs into the user's account (with the merchant), and extract, from the crawled (accessed) purchase-related online documentation, information which can be used to verify the user's actual purchase of one or more identifiable products. The extracted purchase-related information of the user may then be stored in FMDS 210 (via, e.g., data engine 224) for later retrieval for reference or analysis.

Since each merchant may have its own custom way (such as its custom set of user interfaces) to present the user's purchase-related records, backend system 102 may provide (via, e.g., FM business logic module 226), for each supported merchant, one or more “tailor-made” crawler modules specifically implemented to perform the crawling and extraction against the merchant's online platform in accordance with known information concerning ways in which the merchant platform presents or otherwise provides private records of an account holder to the account holder. In one embodiment, backend system 102 may perform the crawling and extraction against a supported merchant immediately following the user's adding the merchant (via UI 510) into the user's merchant list. In one embodiment, backend system 102 may schedule one or more recurring cron jobs created to perform, for each registered user, the crawling and extraction against each merchant in the user's merchant list. Thus, when invoked, a created cron job may, for each of a plurality of registered users, retrieve, from the user's merchant list, information on the registered merchants as well as respective login information for the registered merchants. Then, the cron job may, for each registered merchant, log into the merchant on behalf of the user, invoke one or more crawler modules tailor-made for the merchant, and perform the aforementioned crawling and extraction against the merchant platform, so as to acquire up-to-date purchase-related information of the user that can be used to verify the user's actual purchase of one or more identifiable products.

FIG. 5C is a pictorial illustrating an exemplary display page which an online merchant otherwise presents to a registered user (an account holder) thereof to let the user view the user's own purchase-related information when the user manually logs into the merchant's web site. Specifically, FIG. 5C shows an order history page which Amazon.com (a well-known major online merchant) otherwise displays to a registered user thereof after the user manually logs into the user's account with Amazon.com and makes one or more clicks on links leading to one or more order history pages of the user. For illustration purpose, the exemplary order page has been simplified to include only two products. A skilled artisan appreciates that it is not uncommon that a user may have purchased from Amazon.com dozens of products. For such a user, Amazon.com may provide several (and even dozens of) order history pages as well as provide pagination mechanisms (such as the pagination links 515 shown in FIG. 5C) in order to let the user go page by page to view information about each and every past purchase made therefrom.

As shown, an order history page provided by Amazon.com to a registered user thereof displays purchase-related information that includes information identifying the purchased product (such as the brand name, the model name, and the listed product name) as well as information indicating the actual purchase (such as the price paid for the purchase product and the purchase date). These types of purchase-related information can be used to verify the user's actual past purchases of one or more products from Amazon.com. Thus, in one embodiment, one or more crawler modules tailor-made for Amazon.com may be specifically implemented to crawl order history pages that Amazon.com usually provide to a registered user, and extract from, e.g., each and every order history page, information including, inter alia, information identifying one or more purchased products as well as information indicating one or more actual purchases.

FIG. 5C shows the rendered visual display of an exemplary order history page. A skilled artisan appreciates that the one or more crawler modules tailor-made for a specific merchant is not implemented to deal with the rendered display, but instead implemented to deal with the underlying source code of the rendered display. In the example shown in FIG. 5C, the underlying source code of the displayed order history page is provided as an HTML page having known HTML presentation semantics. Thus, in this example, the one or more crawler modules tailor-made for Amazon.com is specifically implemented to extract, from the underlying HTML source code of the one or more order history pages provided to the user, information that can be used to verify the user's past purchase of one or more products from Amazon.com (such as information identifying one or more purchased products and/or information indicating one or more actual purchases in connection with the identified purchased products).

FIGS. 5D and 5E are pictorials illustrating code snippets including exemplary software code used to implement the exemplary sub-block 502 corresponding to the exemplary display page shown in FIG. 5C. For illustration purpose, exemplary software code shown in the illustrated code snippets are simplified to demonstrate selected implementations discussed above in connection with sub-block 502. Well-known techniques, such as web page crawling (for accessing one or more web pages) and text parsing (for extracting information in different fields), are omitted for clarity.

Referring to FIG. 5D, code snippet 521 includes exemplary software code programmed (in Java programming language) to log into Amazon.com on behalf of the user using the username and password of the user (for logging into Amazon.com), as provided to backend system 102 by the user (via, e.g., UI 510). Code snippet 522 includes exemplary software code programmed to access the underlying HTML source code of one or more order history pages of the user (as provided by Amazon.com) and extract from the underlying HTML source code information that can be used to verify the user's past purchase of one or more products from Amazon.com. Thus, software code shown in code snippet 522 may be included in the aforementioned one or more crawler modules tailor-made for Amazon.com. In this example, for each accessed order history page, software routine 523 (included in code snippet 522) is called to perform the extraction.

Referring to FIG. 5E, which shows a code snippet including software code programmed to implement software routine 523, code snippet 551 shows software code (in the context of software routine 523) used to extract and acquire “title information” of a purchased product. The “title information”, in the context of the instant example, typically includes information identifying the purchased product. For example, for a merchandise good, the title information may include the brand name, the model name, and a listed name for the good. The listed name may include, in addition to a commonly accepted name used to identify the type of the good (such as “refrigerator”, “watch”, “camera”, “camcorder”, and so on), one or more things used to further identify the good (such as the dimensions of good, the materials used to make the good, whether the good is made for men or women, and so on). As another example, for a book, the title information may include the title, the author, the ISBN, the version, and the publisher of the book. Thus, by acquiring the “title information” of a purchased product, backend system 102 may be able to identify a purchased product through information included therein. Code snippets 552A and 552B show software code (in the context of software routine 523) used to extract and acquire the date of an actual purchase. Additionally, code snippet 553 shows software code (in the context of software routine 523) used to extract and acquire the price paid for the purchased product. The acquired information about any or all of the purchase date and the price paid for the purchased product may be used by backend system 102 to verify the actual purchase of the identified purchased product.

Thus, FIGS. 5A-E illustrate one exemplary means to implement block 402 in connection with merchandise products (namely, collecting, from a registered user, information which can verifiably indicate that user has used one or more merchandise products) particularly through collecting information which can verifiably indicate that the user has purchased one or more merchandise products.

A skilled artisan appreciates than other means may be used to achieve the same objective without departing from the scope and spirit of the present disclosure. As one example, in collecting purchase-related information of the user, the disclosed FM system does not have to collect a register user's username and password in order to access the user's account with an online merchant. Instead, the disclosed FM system may receive an authentication token from an online merchant after the user authenticates with the online merchant (if the online merchant supports such a known authentication scheme for letting a third party access the user's personal information saved with the online merchant, as has been provided by online platforms such as Facebook, Google, LinkedIn and Yahoo!), and then use the received token to call APIs (application programming interfaces) of the online merchant, rather than performs the above-described crawling in order to access the user's purchase-related information.

As another example, in collecting purchase-related information of the user, the disclosed FM system may have the user forward one or more purchase (order) confirmation e-mails which the user has received from one or more online merchants (including retail merchants not having respective e-commerce platforms but providing order confirmation e-mails) to an e-mail address of backend system 102. Upon receiving a user-forwarded purchase (order) confirmation e-mail, backend system 102 may (via, e.g., FM business logic module 226) analyze the e-mail, identify the online merchant from which the original purchase confirmation e-mail was sent (through, e.g., analyzing the domain name of the sender of the original confirmation e-mail), and extract from the user-forwarded e-mail information that can be used to verify the user's actual purchase of one or more identifiable products (such as information identifying one or more products purchased by the user as well as information indicating the user's one or more actual purchases) so as verify the user's actual purchase of one or more identifiable products.

As yet another example, in collecting purchase-related information of the user, the disclosed FM system may provide a custom FM client application 310 enabling the user to scan (or take photos of) one or more receipts of a merchant (regardless of whether the merchant has an e-commerce platform) and acquire the scanned images of the receipts. In one embodiment, the acquired images of the receipts are sent to backend system 102 for processing (via, e.g., FM business logic module 226). The processing may include performing OCR (optical character recognition) on the images, analyzing the OCRed text, acquiring (from the OCRed text) information such as merchant information, information indicating one or more products that have been purchased, price paid for each purchased product, date and time of each scanned receipt, and information on the credit card used to pay the purchase (such as the non-masked last 4 digit of a credit card appeared on the receipt). A typical retail receipt, due to its limited size, only contains abbreviated text used to identify one or more purchased products. Thus, the acquiring of information about one or more purchase products may include identifying and extracting abbreviated text (contained in the OCRed text) used to list one or more purchased products, mapping the extracted abbreviated text to corresponding full text so as to identify one or more purchased products. To further verify that the purchases listed on a received scanned receipt were made by the user, backend system 102 may check, e.g., the identified last 4 digit of the credit card used to make the purchases (if appeared on the scanned receipt) against credit card information of the user pre-stored in backend system 102 under the user's account. Additionally or alternately, the custom FM client application 310 may further prompt and enable the user to scan the physical credit card used to make the purchases appeared in the scanned receipt, and send one or more scanned images of the credit card to backend system 102 so as to verify that the purchases listed on the scanned receipt is indeed made by the user. In one embodiment, at least part of the processing described above may be performed on the client side by the custom FM client application 310. For example, the OCR processing may be performed by client application 310.

FIGS. 6A-B are figures illustrating an exemplary means provided by the disclosed FM system and method to implement block 402 in connection with software products—namely, collecting, from a registered user, information which can verifiably indicate that user has used one or more software products.

A skilled artisan appreciates that the exemplary means illustrated in FIGS. 5A-E are applicable to implementation of block 402 for one or more software products if the one or more software products are purchased from one or more online merchants in a manner same as or similar to the manner in which merchandise goods are purchased from the online merchants. On the other hand, for a software product, another way to verify whether the software product has been used by a user is checking a computing device of the user to see whether the software product was in fact installed on the computing device of the user, since installation of the software product, to an appreciable extent, indicates that the user may have used the software product, and thus may be suitable to provide feedback on the software product. FIGS. 6A-B illustrate an exemplary means (used to implement block 402) based on the checking of whether a software product (program) has been installed on a computing device of a user.

FIG. 6A is a flowchart illustrating a process in which the exemplary means uses to implement block 402 in connection with one or more software products. At sub-block 601, a registered user of the disclosed FM system installs on each of one or more client devices 101 of the registered user a custom FM client application 310 which includes a software module specifically programmed (as, e.g. part of FM business logic function 326) to collect up-to-date information about software programs installed on the client device 101. For each client device 101 where a custom FM client application 310 is installed, the installed FM client application 310 is programmed for the operating system on which the client device runs or supports. For example, if the client device 101 is a smart phone or tablet runs on an Android operating system or a work station emulating an Android operating system, the FM client application 310 installed thereon is one programmed for the Android operating system. In other examples, an installed FM client application 310 may be programmed for one of other operation systems (running on a host client device 101), such as an iOS operating system (for an iPhone or iPad of Apple) or a Windows operating system (for one of desktop computers, laptop computers or smart mobile devices).

In one embodiment, after the installation, the installed FM client application 310 displays a user interface for login, prompting the user to log into backend system 102. After the user logs into backend system 102, in one implementation, the client application 310 may store the login information received from the user interface locally in the host client device 101, so that the client application 310 may automatically log into backend system 102 on behalf of the user when the client application 310 is started on the host client device 101 in the future. In one embodiment, with the user's permission (via, e.g., a click-wrap “terms and conditions” agreement displayed on the client device or on a web site of backend system 102), the installed FM client application 310 is configured to run on a host client device 101 every time when the host client device 101 is started (powered up and running), and thus is able to collect up-to-date information about software programs installed on the host client device 101 whenever the host client device 101 is started and in operation.

At sub-block 602, from time to time, for each hosting client device 101 of the registered user, the installed custom FM client application 310, when running on the hosting client device 101, collects information about up-to-date software programs installed on the hosting client device 101. For each installed software program, the collected information may include the name of the software program, the build version (build number) of the software program, the creator of the software program, and the installation time. The collected software program installation information may then be transmitted to backend system 102 so that backend system 102 may, from time to time, store or update information about installed software programs stored therein (in, e.g. user data DS 201 of FMDS 210) for the account of the registered user (via, e.g., FM business logic module 226 and data engine 225). In one embodiment, the host client device 101 does not start to collect installed software program information until after the client device logs into backend system 102 on behalf of the user.

By way of example and not limitation, FIG. 6B is a pictorial illustrating exemplary code snippets programmed to collect information about software programs installed on a hosting client device 101, as is part of sub-block 602. Specifically, the illustrated exemplary software code is programmed to collect information about software programs installed on a client device 101 running an Android operating system. Code snippet 611 is programmed to call a function provided by the Android operating system to get information about software packages installed on the client device. Then, a programmatic list of information on software packages returned by the Android operating system is iterated to extract information for each software package included in the returned programmatic list. During each iteration, code snippet 612 is executed to acquire a programmatic object containing information about a software application (program) for the software package, and code snippet 613 is executed to obtain information identifying the software application (such as the name, the published version, the build version of the software application) as well as information indicating the installation of the software application on the host client device (such as the time at which the application is installed on the host client device). Thus, with the illustrated software code, the FM client application 310 manages to collect information about software programs installed on a host client device 101. As a skilled artisan appreciates, although the illustrated software code is programmed for an Android operating system, similar software code may be programmed for a different operating system to achieve the same functionality of collecting information about software programs installed on a hosting client device 101 running on the different operating system.

Additionally, in one embodiment, with the user's permission (via, e.g., a click-wrap “terms and conditions” agreement displayed on the client device or on a web site of backend system 102), the client application 310 may optionally collect software usage information (in connection with one or more installed software programs) by monitoring one or more installed software programs that are running on the client device. For each software program, the collected software usage information may include time and day each time the software program is started, and time and day each time the software is shut down. The collected usage time may also be transmitted to backend system 102 for storage and update under the user's account with backend system 102.

Thus, FIGS. 6A-B illustrate one exemplary means to implement block 402 in connection with software products, particularly through collecting information which can verifiably indicate that the user has installed one or more software products.

To summarize for FIGS. 5A-E and FIGS. 6A-B as well as descriptions and discussions thereof and therefor, there can be various means designed and calculated to implement block 402 (namely, collecting, from a registered user, information which can verifiably indicate that user has used one or more identifiable products) without departing from the spirit and the scope of the present disclosure. For different types of products, there can be custom means specifically tailored to the different types and used to implement block 402 without departing from the spirit and the scope of the present disclosure.

Also, as a skilled artisan appreciates, code snippets shown in FIGS. 5D-5E and 6B are for illustration purpose only. There can be myriad different ways to program software code that achieve the same or similar functionalities which the software code shown in those code snippets are programmed to achieve. More specifically, software code written in a programming language other than the Java programming language, such as C, C++, C#, Python, Perl and so on, can be used to achieve the same or similar functionalities. Even using the same Java programming language, myriad different sets of software code may be programmed to achieve the same or similar functionalities.

Returning to FIG. 4 (which is the flowchart illustrating an exemplary main process of the disclosed FM system), as noted above, via block 402, the disclosed FM system manages to collect information indicating, with appreciable probability, the user's actual use of one or more identifiable products. As a result, with the collected information, the disclosed FM system, for the purpose of deciding whether the user is suitable or qualified to leave feedback on one more products, effectively verifies, with appreciable certainty, that one or more products have been in fact used by the user. Hereinafter, for ease of discussion, one or more products of the user which have been effectively verified through the information collected at block 402 will be referred to as one or more “verified products.”

At block 403, the disclosed FM system matches each of the user's verified products to an officially identified product stored in, e.g., product DS 232 of FMDS 210. In one embodiment, product data DS 232 of FMDS 210 is configured to be a data store storing a consolidated collection of “officially” identified products on which the disclosed FM system allows a registered user to provide feedback. At times, different merchants may use slightly different “title information” (as exemplified in FIG. 5E) for a same product. So for the disclosed FM system—which likely collect product information from different users all having made purchases of a particular product but from different merchants—if block 403 and the consolidated product data DS 232 are not provided, multiple products separately listed for displaying feedback thereon may turn out to be a same product.

A skilled artisan appreciates there can be various implementations working separately or working in concert to construct the consolidated product data DS 232. As a first example, in one implementation, product crawler modules (as, e.g., part of FM business logic module 226) may be programmed and launched to crawl major online merchant platforms (such as Amazon, Walmart, Home Depot, Sears, Lowe's, Best Buys, and etc.) so as to collect data identifying hundreds of thousands of different products that are sold in these stores. Then, the collected data identifying each product are then analyzed and separated into different applicable categories. For a consumer good, applicable categories may include brand name, model name (or number), listed product name, dimension(s), sex (man or woman) made for, and the main material made of (e.g. “stainless steel”). For a book, applicable categories may include ISBN, author, title, publisher and edition. For a software program, applicable categories may include software name, published version, build version and one or more supporting operating system platforms.

In one implementation, if it is known that for a certain product, the respective values for a set of categories can collectively identify the product, the set of categories may then be used to identify the product, regardless of what values for other categories are. Using the products listed in an exemplary order history page shown in FIG. 5C as an example, if the brand name “Seiko” and the model name “SNK607” collectively identify a watch product, then regardless of what the listed name for that product (as collected from a merchant like “Amazon”) is, the set of categories “brand name” and “model name” are used to identify the product. Hereinafter, a category amongst a set of categories which are used to collectively identify a product with their respective values, will be collectively referred to as an “identifying category”, and a category outside of the “identifying categories” will be referred to as a “non-identifying” category.

In most cases, for a product that can be identified by a known set (combination) of identifying categories (such as brand name and model name), different sets of data each collected from a different merchant and used by the different merchant to identify the product, after routine processing (such as mapping each known standard abbreviation to a corresponding full text), usually have same respective values for each identifying category, despite that text-wise (value-wise), the different sets of values (data) may be slightly different with respect to those non-identifying categories. As an example, for this “Seiko SNK607” watch product, typically, different merchants uniformly use “Seiko” as the brand name and “SNK607” as the model name when referring to this watch product, despite these different merchants may use slightly different values (text) for one or more other non-identifying categories—Amazon, in this case, uses “automatic black dial stainless steel watch” as Amazon's “listed name” for this watch product, while another merchant may use slightly different text as its listed name for this watch product.

After different sets of product-identifying data are collected from different merchants (by, e.g. the above-noted product crawler modules) and the collected data identifying each product are analyzed and separated into different applicable categories, additional processing is performed to consolidate different data sets referring to a same product into one single data set identifying the referred product. In one implementation, in performing the consolidation, for each identifying category (such as “the brand name”), values for the identifying category from different data sets (which, as noted above, are typically the same) are consolidated into the one same value (such as “Seiko” in the “Seiko SNK607” watch example) for the identifying category in the single data set. For each applicable non-identifying category (such as the above-noted “listed name” category), whose values for that category may, as noted above, vary from merchant to merchant, the value for that category collected from an “appointed” merchant (such as Amazon) may be used as the “official” value for that category in the single data set. The consolidated single data set may then be transferred to and stored into product data DS 232 so as to use the data (values for categories) of the stored single data set as the “official data” used to identify the referred product. This process (employed to consolidate data for one referred product) may be repeated for hundreds of thousands of products so that product data DS 232 contains hundreds of thousands of consolidated data sets each having “official data” used to identify a particular product.

As a second example of implementations used to construct the consolidated product data DS 232, the disclosed FM system may receive or otherwise acquire product-identifying data for various types for products from a plurality of data sources already having possession of product-identifying data for various types for products. As one example, the disclosed FM system may request for (through, e.g. purchasing) and receive data identifying different appliances from one or more major appliance distributors. As another example, the disclosed FM system may crawl one or more web sites of one or more major retail chains specializing in selling consumer electronics, and acquire data identifying different consumer electronics from the crawling. As yet another example, the disclosed FM system may request for and receive data identifying different books from one or more major book publishers.

It is likely that one or more received sets of product-identifying data have already been consolidated at one or more provision sources (such as the above-noted one or more major book publishers). Thus, in one implementation, after receiving a set of product-identifying data from a provision source (information vendor), the disclosed FM system may, e.g., programmatically convert the received data set into one or more data sets suitable for being transferred to and stored into product data DS 210, thus incrementally adding the one or more converted data sets into product data DS 210. In one implementation, before a converted data set identifying a particular product is incrementally added into product data DS 210, the underlying data of the data set is first checked against product data DS 210 to see if there is already a data set identifying the same product that has been stored in product data DS 210. The incremental adding of the converted data set only takes place if there is no such a data set. This incremental-data-adding process may be repeated for each and every data set identifying a particular product as received from or otherwise acquired from a provision source.

With respect to block 403, in matching a user's verified product to an officially identified product stored in product data DS 232, backend system 102 may compare the product-identifying information which backend system 102 acquires via block 402—such as the “title information” which code snippet 551 of FIG. 5E manages to acquire or the product-identifying information which code snippet 613 of FIG. 6B manages to acquire—against “official” product-identifying information stored in product data DS 232.

In one implementation, backend system 102 may analyze the product-identifying information (identifying the verified product) acquired from block 402 and extract from the acquired product-identifying information values for applicable categories. For example, in the example illustrated in FIGS. 5C-5E, backend system 102 may extract, from the acquired “title information”, “Seiko” for the “brand name” category, “SNK607” for the “model name” category, “men” for the “sex made for” category, “stainless steel” for the “material made of” category, and “automatic black dial stainless steel watch” for the “listed name” category, according to known text patterns exhibited in the underlying HMTL code of typical order history pages generated by Amazon. This step may be performed using software code tailor-made for the merchant from which the product-identifying information is acquired. Backend system 102 may use then extracted values for known identifying categories (such as the “brand name” and “model name” categories for some consumer goods) to query against product data DS 232. If a single entry identifying an “official” product—which, in one example, is a single data set comprising values for a set of identifying and non-identifying categories (fields)—is returned in the query result, then backend system 102 successfully matches the verified product to an officially identified product stored in product data DS 232.

In one implementation, if, after the analyzing and extracting step, not all identifying categories amongst known identifying categories are available with values therefor, backend system 102 may simply use values for the sub-set of available identifying categories (amongst known identifying categories) to query against product data DS 232. If multiple entries each identifying an “official” product are returned in the query result, then backend system 102 may compare the values (of the verified product) for applicable non-identifying categories against values for corresponding categories of each returned entry, and select a returned entry which the backend system 102 computes to be the one whose officially identified product, when all categories are considered as a whole, is closest to the verified product among the respective officially identified products of the returned entries.

The product-identifying information of the selected entry may be further compared to the product-identifying information of the verified product so as to get a “similarity score” based on how similar the former is to the latter. One exemplary way of calculating the similarity score is calculating the percentage of the words (not abbreviated words) in the normalized (processed) product-identifying text of the verified product which are also included in the product-identifying text (values) for the categories (fields) of the selected entry. If the similarity score is above a pre-set threshold (such as 90 out of a maximum 100), then the selected entry is considered a matching entry. In this case, backend system 102 considers the verified product as successfully matching to the officially identified product of the selected entry.

If the similarity score is below the pre-set threshold, then backend system 102 is considered failing to match the verified product to an officially identified product stored in product data DS 232. In this case, backend system 102 considers the verified product as a product which the disclosed FM system sofar has not “officially” identified (or, in other words, supported) for the purpose of allowing a user to leave feedback thereon. When such an event (namely, a failure to match a verified product to an “officially” identified product) occurs, backend system 102 may log the event so as to prompt a human operator or a relevant software module to investigate whether a corresponding “officially identified product” exist and should be added to the product data DS 232.

A skilled artisan appreciates that the implementations described above in connection with block 403 are exemplary. There can be various other implementations used to implement block 403 (or similar functions) without departing from the spirit and the scope of the present disclosure. In particular, a skilled artisan appreciates an implementation used to implement the matching of a verified product of the user to an officially identified product stored in product data DS 232 may depend on how product data DS 232 is configured and structured in terms of establishing a “library” collection of uniquely identified products.

Also, with respect to block 403, it is noted that block 402, due to its on-going and from-time-to-time nature, may be executed after block 403 is executed. Specifically, collecting information indicating the user's actual use of one or more identifiable products, as is performed at block 402, is not a one-time task, but instead is a task that may be regularly on-going and performed regularly from time-to-time in order to ensure that backend system 402 contains the most up-to-date information indicating the user's newly discovered actual use of identifiable products which the user may had not used in the past. Thus, one instance of block 402 may very well be performed after one instance of block 403, or even one instance of either block 404 or 405 (which will be described below) is performed.

At block 404, the disclosed FM system (via, e.g., backend system 102) enables the user to provide feedback on one or more officially identified products which are verified, with appreciable certainty, to have been used by the user.

Specifically, after a verified product of the user is matched to an officially identified product stored in product data DS 232 via block 403, in one embodiment, the one matched product is added to a “certified product list” stored in user data DS 231 under the user's account. Thus, for a user, only a verified product of the user which has been successfully matched to an officially identified product stored in product data DS 232 can find its way to the user's certified product list. In one implementation, for each officially identified product included in the “certified product list”, an identifier (hereinafter referred to as “pointer identifier”) functioning as a pointer pointing to the single entry for (identifying) the officially identified product, is included in the certified product list for identifying the included officially identified product. Thus, in this embodiment, backend system 102, in implementing block 404, is programmed and configured to allow the user to leave feedback only on an officially identified product included in the certified product list stored under the user's account. This is due to the consideration that only a product included in the user's certified product list is an officially identified product which has been verified, with appreciable certainty, to have been used by the user. Hereinafter, for the ease of discussion, such a product is referred to as a “certified product.”

Also, in one embodiment, backend system 102 is programmed and configured to allow the user to only provide a single instance of feedback on each particular certified product, thus eliminating or reducing user abuses resulting from the user “flooding” multiple instances of feedback on the particular certified product. In one implementation, backend system 102 is programmed and configured to allow the user to update the single instance of feedback on a certified product, so as to address the user's possible need to update his/her feedback thereon while maintaining the mechanisms installed to ensure that the user can only provide a single instance of feedback thereon.

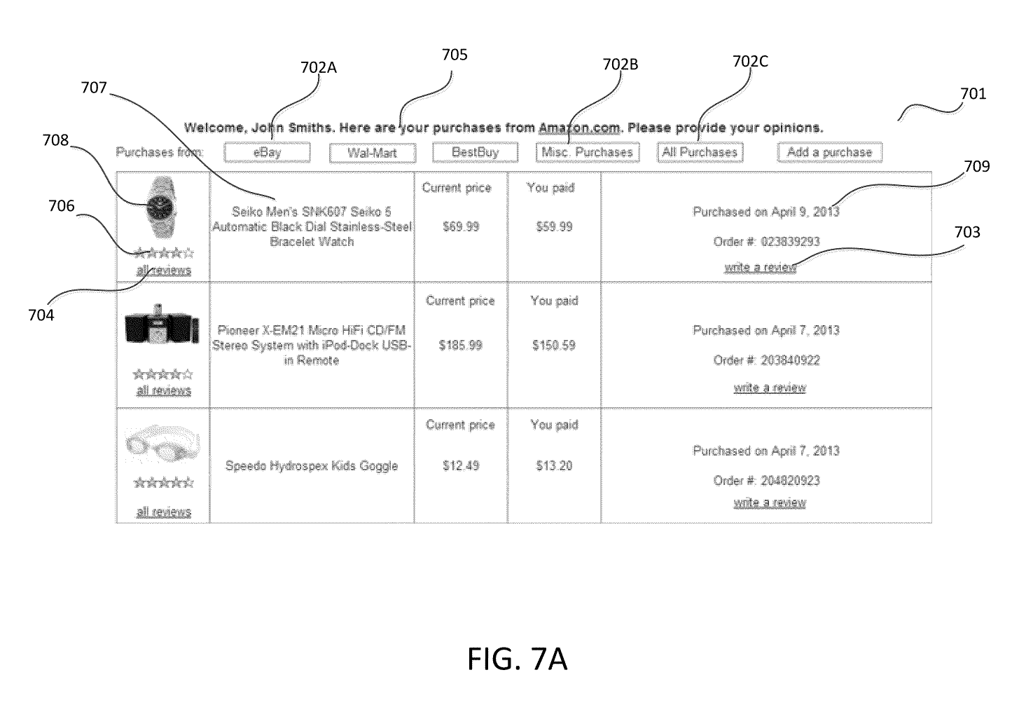

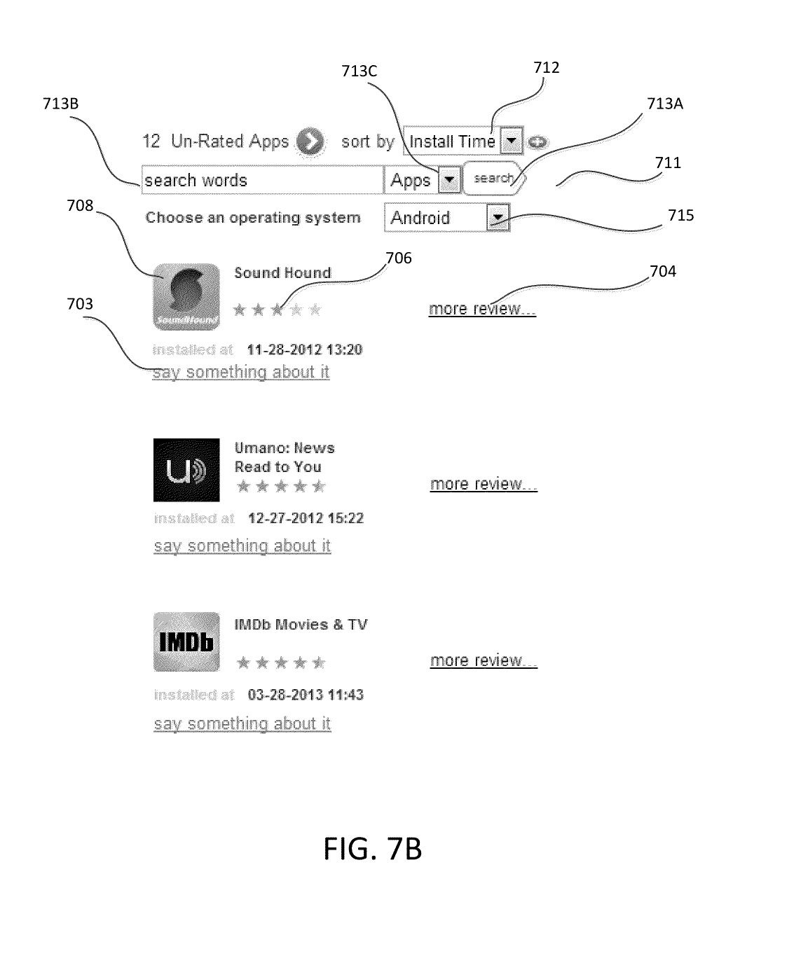

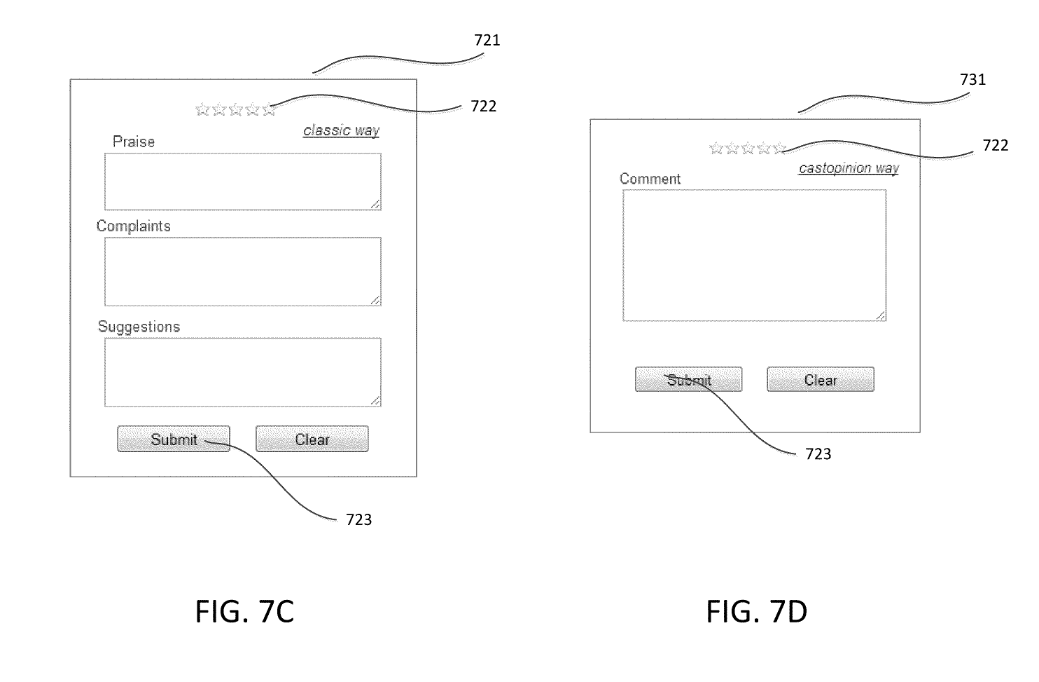

FIGS. 7A-E are pictorials illustrating exemplary UIs provided to enable the user to provide feedback on one or more certified products of the user, according to one or more embodiments of the present disclosure. In one implementation, those or similar UIs are implemented by GUI engine 225 of backend system and displayed by a browser 311 on a client device 101 of the user. In one implementation, those or similar UIs are implemented and displayed by a FM client application 310 on a client device 101 of the user. Referring to FIG. 7A, exemplary UI 701 is provided, on one hand, to let user view (and thus be aware of) one or more certified products of the user on which feedback have not yet been provided, and on another hand, to enable the user provide feedback on one or more certified products.

By way of example and not limitation, caption 705 is provided to indicate a selected (or default) merchant from which the one or more certified products are purchased. Also, the caption provides other information (such as the user's name and information indicating what UI 701 is for) so as to let the user be informed of the purpose and the nature of UI 701 as well as the fact that UI 701 is specifically provided for the user. If the user would like to view one or more certified products purchased from other merchants, the user may click one of an array of “purchase source” buttons 702 provided to give the user options with regard to one or more purchase sources of the user's certified products included in the user's certified product list. In one implementation, buttons 702 may include a selected number of “merchant” buttons 702A (such as three “merchant” buttons) each labeling a name (or an abbreviated name) of a merchant which is among one of the selected number of “top” merchants (outside of the “current” merchant for which UI 701 is displayed) from which the user has purchased the most number of certified products.

Thus, if the user selects (by clicking) the “eBay” button 702A, the one or more certified products displayed in UI 701 are switched to ones purchased from eBay, and the clicked button 702A may be relabeled to “Amazon”, which is a name for the “previous” merchant Amazon.com. Clicking the button 702B labeled “Misc Purchases” may result in UI 701 being configured to display certified products purchased from merchants other than the “top” merchants whose names are respectively listed on the limited number of “merchant” buttons 702B. Clicking the button 702C labeled “All Purchases” may result in UI 701 being configured to display all certified products of the user (possibly via pagination means as needed) without any regard to merchants (from which the certified products were purchased).

In one implementation, each certified product listed in UI 701 is retrieved from the aforementioned single certified product list stored under the user's account. For each listed certified product, UI 701 may provide UI element 707 configured to list information identifying the certified product. In one implementation, backend system 102, via data engine 224, retrieves the aforementioned pointer identifier for the certified product (as stored in the certified product list” for identifying the certified product) from the user's account, and uses the pointer identifier to locate the single entry (identifying the certified product) stored in product data DS 232, retrieves values (text) for applicable categories for the single entry, and assembles (packages) the retrieved values to form the text displayed in UI 701 for the listed certified product. UI 701 may be configured to further provide UI element 708 configured to display an image showing the certified product (which may be collected and stored in product data DS 232 as part of one or more processes of constructing the product data DS 232). Additionally, UI 701 may provide UI element 709 configured to display information indicating an actual purchase of the certified product (which may be collected and stored via block 402).

Also, for each listed certified product on which the user's feedback has not yet been provided, a clickable UI element 703, such as link 703, is provided to enable the user to input his/her feedback. Clicking link 703 results in an UI displayed for inputting the user's feedback. For each listed certified product, a clickable UI element 704, such as link 704, is provided to let the user view outstanding reviews (feedback) on the certified product. UI element 706 configured to visually display the current “star” rating of the certified product is provided immediately above link 704 so as to give the user quick summary information about a current overall rating on the listed certified product (as, e.g., drawn and calculated from feedback provided on the same listed certified product by other registered users of the disclosed FM system).

FIG. 7B illustrates another exemplary UI 711 provided to enable the user input feedback on one or more certified products. On one hand, UI 711 is, in some aspects, similar to UI 701. For example, they both list certified products on which the user has not yet provided feedback, and provide UI elements to enable to user to provide feedback on one or more listed certified products. On the other hand, UI 711 also differs from UI 701 in some aspects. For example, UI 711 provides one or more configurations applicable to software products and adapted to the nature of software products. Specifically, UI 711 provides UI element 712 (which, in one implementation, is drop-down list 712) configured to enable the user to sort the displayed list of certified products based on a selected criterion, such as installation time (of a software product) or product name. Besides, UI 711 provides UI element 715 (which, in one implementation, is drop-down list 715) configured to enable the user to list certified software products running on or supporting a selected operating system platform, such as Android, iOS or Windows. Additionally, UI 711 provides UI elements 713A, 713B and 713C collectively configure to enable the user to search for certified products (against, e.g., the certified product list of the user) on which the user would like to provide feedback.

A skilled artisan appreciates that the exemplary UIs 701 and 711 shown in FIGS. 7A and 7B are for illustration and not for limitation. As shown, UIs 701 and 711 are configured to facilitate the user to view certified products of the user on which the use have not yet provided feedback. Also, UIs 701 and 711 are configured to help to ensure that the user can only provide a single instance of feedback on a particular certified product of the user. Besides, UIs 701 and 711 provide one or more configurations that may be specifically applicable to one or more certain types of certified products displayed therein and adapted to the respective natures thereof. Thus, any other UI may be additionally or alternatively provided without departing from the scope and spirit of the present disclosure so long as the provided UIs effectively achieve some or all of these objectives or preferences.

FIGS. 7C and 7D illustrate exemplary UIs 721 and 731 provided to enable the user to input feedback on a selected certified product. Specifically, UI 721 or UI 731 may be displayed as a result of the user clicking on a UI element 703 in either FIG. 7A or FIG. 7B so as to provide UI elements through which the user may input feedback on the certified product for which the clicked UI 703 is provided. Both UI 721 and UI 731 include an UI element 722 which enables the user to provide a conventional “star” rating on the certified product, and a “submit” button 723 which enables the user to submit the provided feedback to backend system 102. Compared to UI 731, UI 721 provides more tailored (or, in other words, more granular) text input fields for providing literal review on the certified product. Other feedback-leaving UIs specifically tailored to one or more certain types of certified products may be additionally or alternatively provided. In one implementation, different feedback-leaving UIs may be displayed for different types of certified products for feedback-leaving. For example, UI 721 may be displayed for feedback-leaving on consumer electronic products, and UI 731 may be displayed for feedback-leaving on software products.

Returning to FIG. 4, at block 405, the disclosed FM system publishes the user's feedback provided on one or more certified products. In one embodiment, after the user provides, and submits to backend system 102, feedback on a certified product thereof through one or more UIs (such as UI 721 or UI 731) displayed on a client device 101 via a client application 306 (such as a browser 311 or a FM client application 310), backend system 102, upon receiving the submitted feedback, stores the submitted feedback in feedback data DS 233 of FMDS 210. On one hand, the stored feedback may be linked to the single entry (identifying the certified product) stored in product data DS 232. On another hand, the stored feedback may be linked to the user's account stored in user data DS 231.

The stored feedback may be further linked to the pointer identifier for the certified product as included in the certified product list stored (in user data DS 231) under the user's account. In other words, backend system 102 is programmed and configured to retrievably store the submitted feedback such that the submitted feedback is recorded as the single instance of feedback which the user provides on the certified product, thus helping to ensure that user can only provide a single instance of feedback thereon.

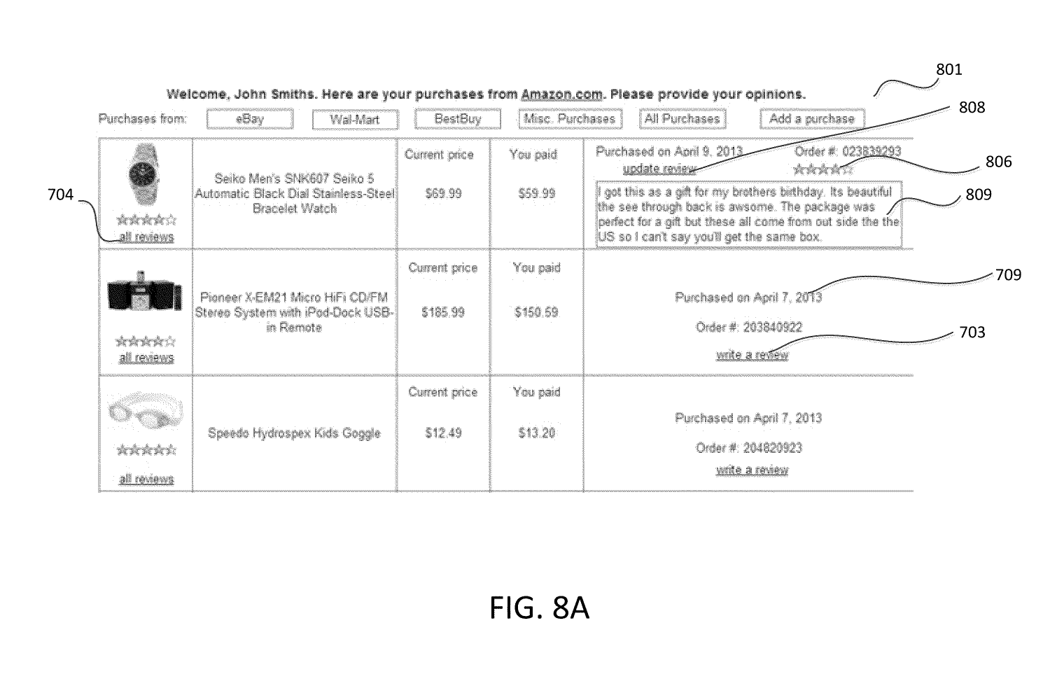

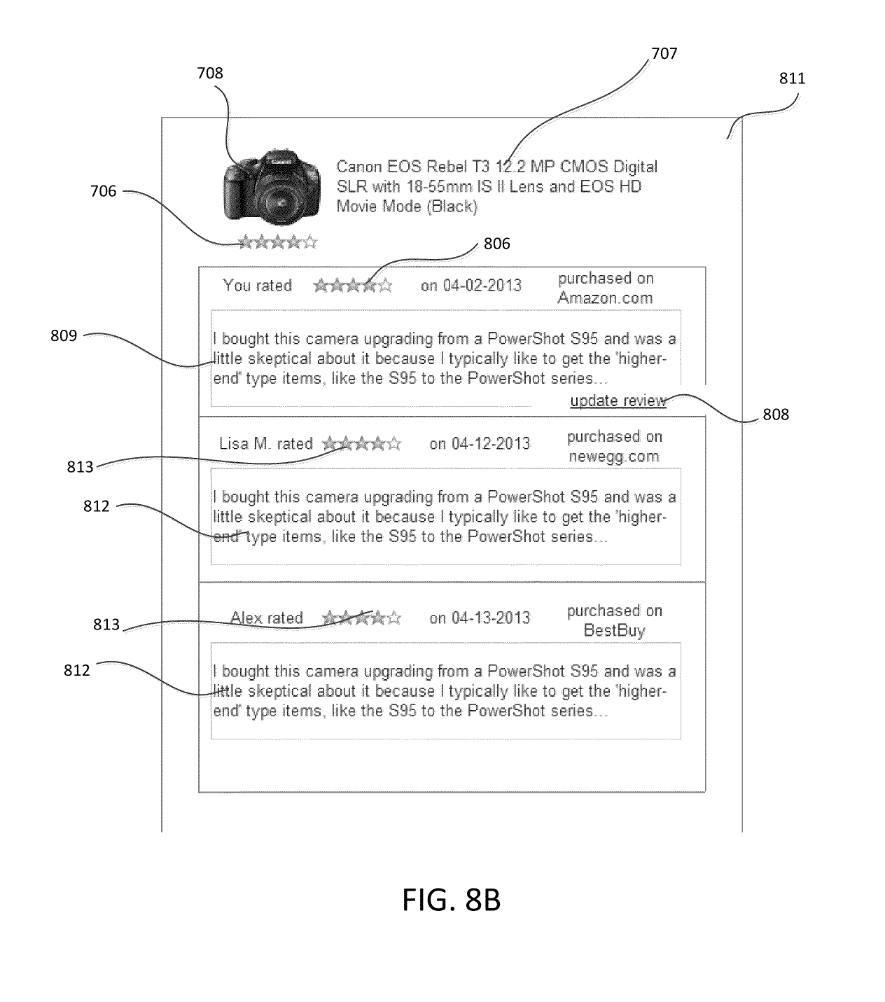

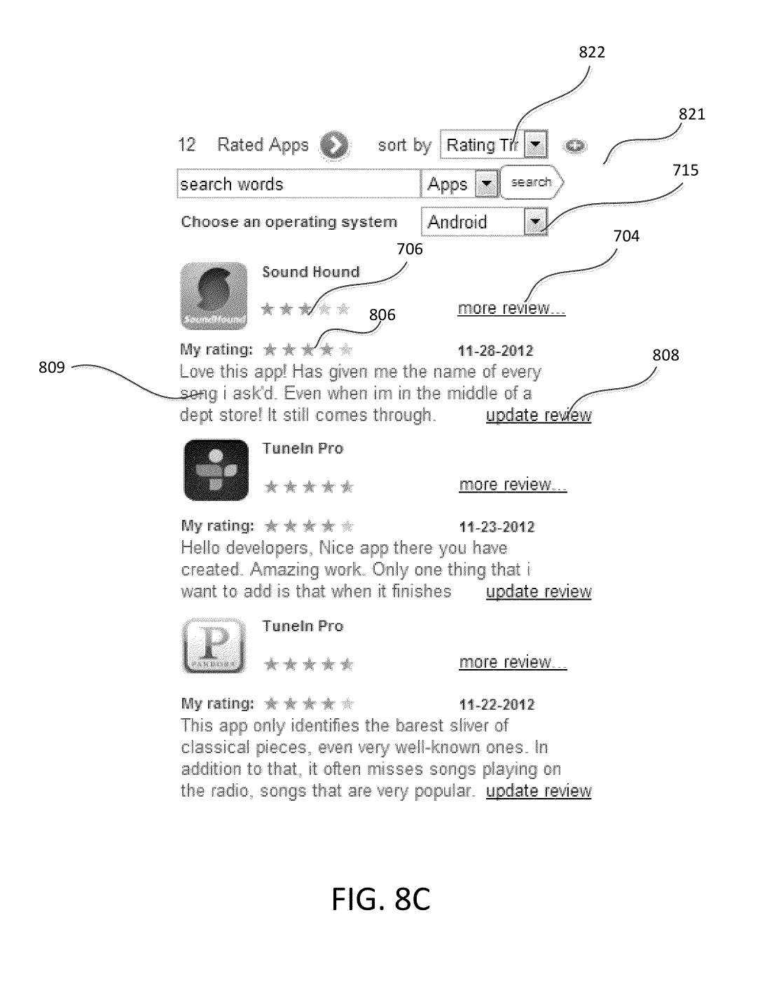

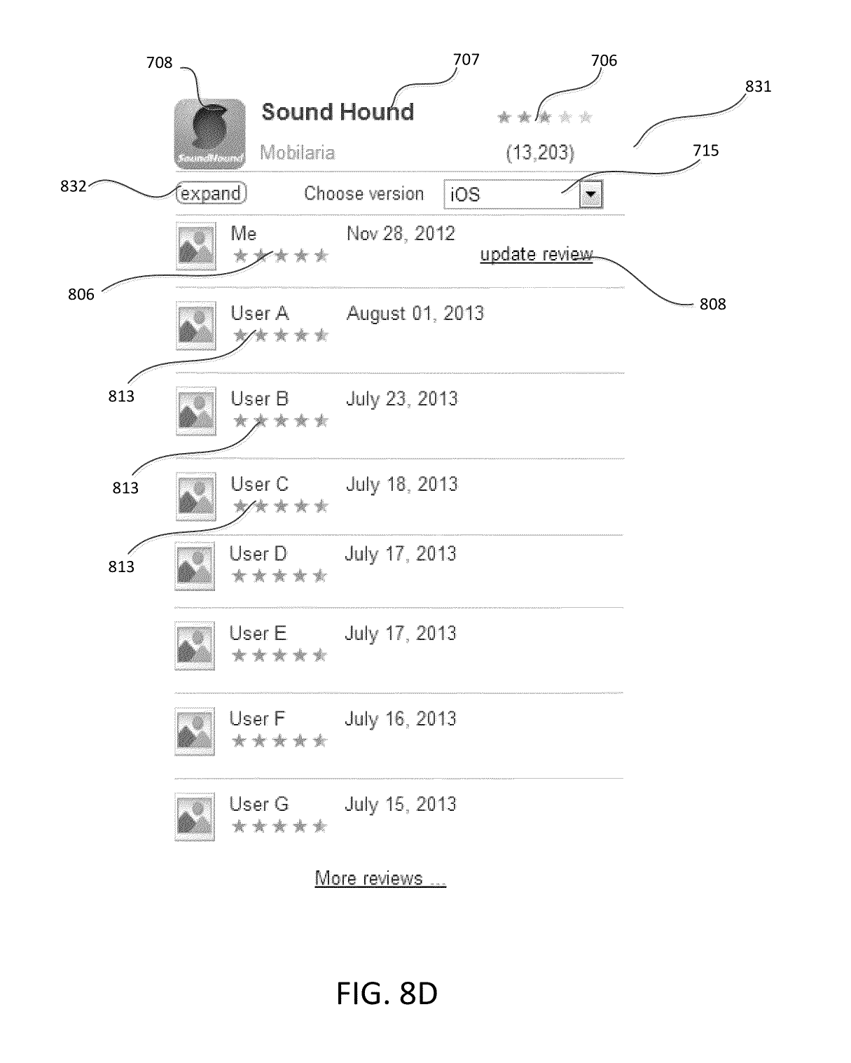

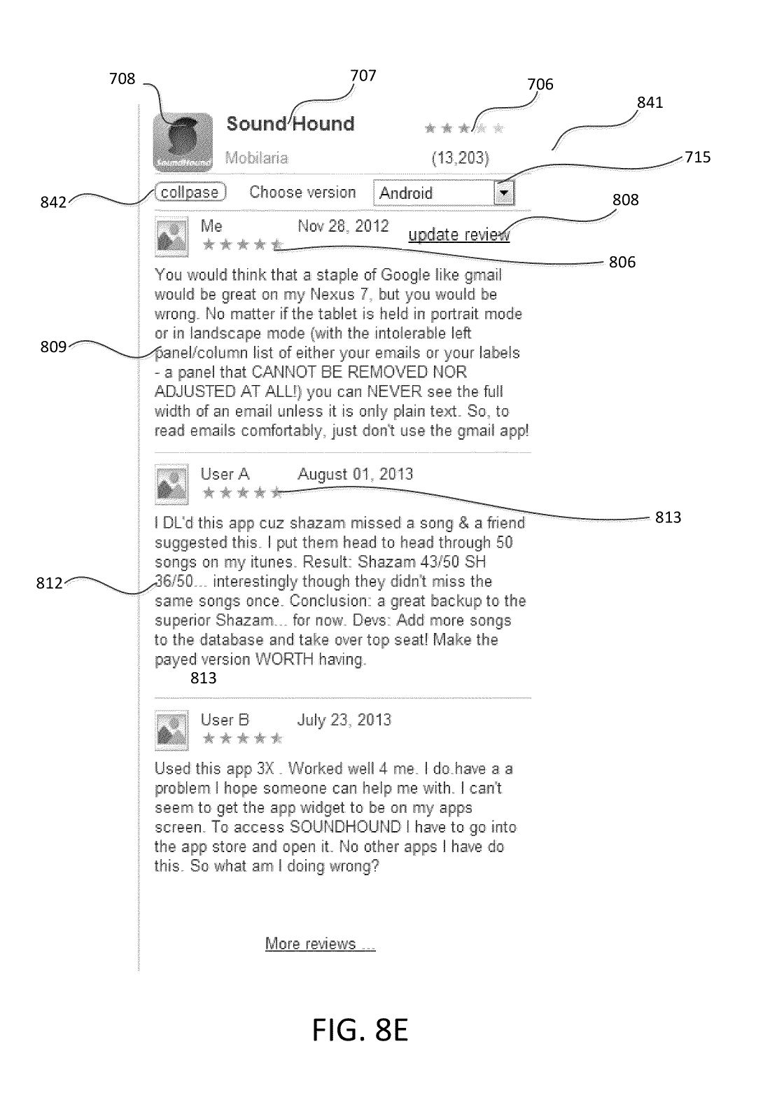

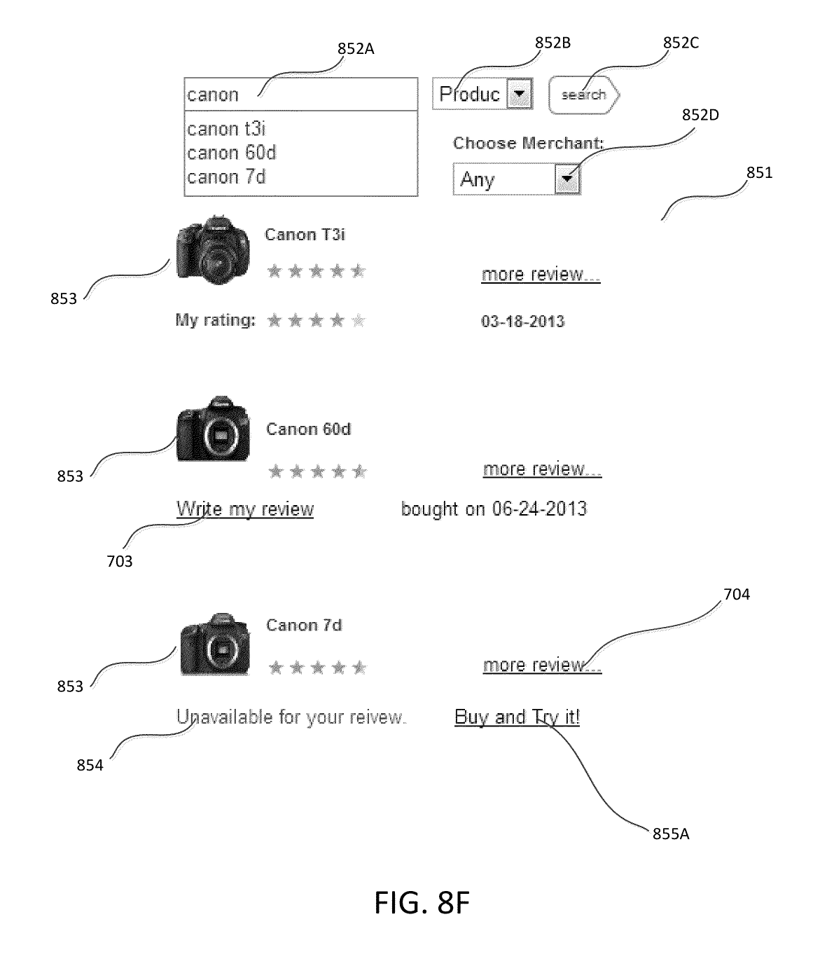

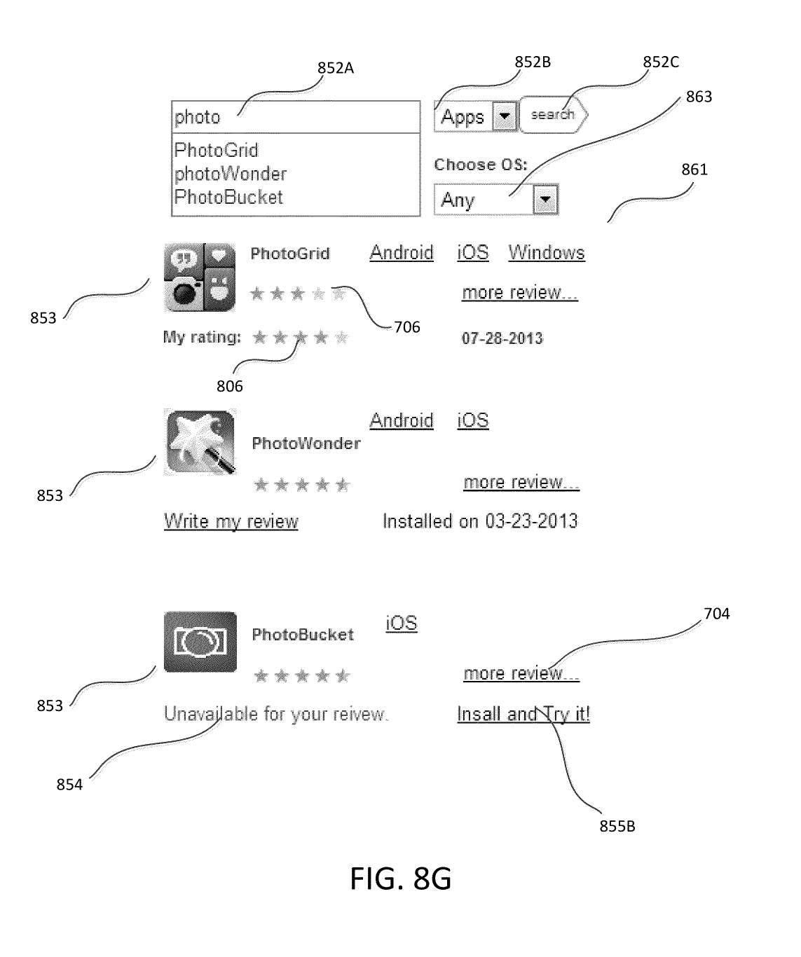

FIGS. 8A-G are pictorials illustrating exemplary UIs configured to enable the user to view the user's own feedback on a certified product of the user as well as other user's feedback on one or more certified products. Referring to FIG. 8A, after backend system 102 retrievably stores in FMDS 210 the feedback which the user provided and submitted on the certified product, the user may view the user's own feedback (provided on the certified product) through an exemplary UI 801, which is configured to display the user's own feedback on one or more certified products of the user. In one implementation, UI 801 is the same as or similar to UI 701 (exemplified in FIG. 7A), except that, inter alia, the former displays the user's own feedback on the certified product while the latter does not. The displayed user's own feedback includes, e.g., UI element 806 displaying the user-provided “star” rating on the certified product and UI element 809 displaying the user-provided literal review on the certified product. Specifically, the content of the user's own feedback on the certified product (which, e.g., includes the user-provided “star” rating and the user-provided literal review on the certified product) is retrieved from FMDS 210 (via, e.g., feedback data service module 223 of data engine 224) before being displayed on a client device 101 of the user. Additionally, clickable UI element 808 is provided to enable the user to update the single instance of the feedback on the certified product.

Referring to FIG. 8B, exemplary UI 811 is provided to enable the user to view comprehensive feedback provided on a certified product. In one implementation, UI 811 is displayed when the user, e.g., clicks a link 704 displayed (in, e.g., UI 801, UI 701 or UI 711) corresponding to the certified product. In one implementation, UI 811 is configured to display, if available, the user's own feedback on the certified product. Also, UI 811 is configured to display other registered users' feedback on the same certified product, which includes UI elements 813 each displaying the “star” rating provided thereon by another user and UI elements 812 each displaying the literal review provided thereon by another user. Additionally, UI is configured to display the overall “star” rating 706 on the same certified product, with the overall rating 706 reflecting the rating provided by the user if applicable. In one implementation, the overall “star” rating is calculated by averaging all the ratings provided by applicable registered users on the certified product.

Referring to FIG. 8C, similar to UI 801, UI 821 is an example UI provided to enable the user to view the user's own feedback provided on a list of certified products on which the use has provided feedback. In one implementation, UI 821 is the same as or similar to UI 711 (exemplified in FIG. 7B), except that, among other things, the former displays the user's own feedback on the certified software product while the latter does not. Additionally, similar to UI 711, UI 821 also provides one or more configurations particularly applicable to software products and adapted to the nature of software products. For example, UI 821 provides UI element 822 configured to enable the user to sort displayed instances of feedback on the listed certified products based on the rating time (namely, the time at which a rating is provided on a software product) or other criteria, such as product name. Additionally, UI 821 provides UI element 715 configured to enable the user to list reviews on certified software products running on or supporting a selected operating system platform, such as Android, iOS or Windows.

Referring to FIGS. 8D and 8E, similar to UI 811 exemplified in FIG. 8B, exemplary UIs 831 and 841 are provided to enable the user to view comprehensive feedback provided on a certified product. Thus, any of FIGS. 8D and 8E may be displayed as a result of the user clicking on a link 704 provided corresponding to a certified product listed in UIs such as UIs 701, 702, 801 and 821. In one implementation, UI 831 is configured to provide a condensed (collapsed) view of feedback (including the user's feedback as well as other users' feedback) provided on the certified product. In one implementation, UI 831 is configured to only display “star” ratings (which include the user's “star” rating 806 and other users' “start” ratings 813) on respective listed instances of feedback. Clicking UI element 832 labeled “expand” results in the display of UI 841, which is configured to provide an expanded view of feedback (including the user's feedback as well as other users' feedback) provided on the certified product. In one implementation, UI 841 is configured to display not only “star” ratings on respective listed instances of feedback but also literal reviews (which include the user's literal review 809 and other users' literal reviews 812) on respective listed instances of feedback.

FIGS. 8F and 8G illustrates exemplary UIs 851 and 861 that a user (registered or non-registered) may use to view published feedbacks on an inputted product. As shown, in searching for one or more target products, the user may, through one or more input fields—such as input field UI element 852A, criterion selector 852B, merchant selector 852D, and/or OS selectors 863—input relevant criteria for the search, thus rendering the search more targeting and more efficient.

For each resulting listed product 853, the user may view an overall rating 706 and its own rating 806 if the user is a registered user and has provided a rating. If the user is a registered user eligible to provide a rating on the product 853 but has not yet provided a rating, the user may use link 703 corresponding to the product so as to provide a review. If the user is not eligible to provide a rating, UI element 854 informs the user of such and UI element 855A or 855B provides a clickable link which leads the user to a URL facilitating the user to perform a recommended action. If the user prefers to view more details of comprehensive feedback provided on a particular product, the user may click link 704 corresponding to the product so as to view an expanded UI (such as UI 811 or UI 841) providing more detailed feedback on the corresponding product.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

Therefore, it is intended that the disclosure not be limited to the particular embodiments disclosed for carrying out this disclosure, but that the disclosure will include all embodiments falling within the scope of the appended claims.

What is claimed is:

1. A system of managing feedback on products provided by the user, the system comprising:
means for registering a user;
means for collecting, from the registered user, information verifiably indicating, to an appreciable extent, that the user has used a product identified by the collected information;
means for matching the product to an officially identified product stored in a product database;
means for enabling the user to provide a single instance of feedback on the matched product; and
means for enabling the user to view the feedback provided by the user on the matched product as well as the feedback provided by other registered users on the matched product.
